(19) United States
(12) Patent Application Publication
(10) Pub. No.: US 2026/0174283 A1
(43) Pub. Date: Jun. 25, 2026

(54) INTEGRATED SYSTEM FOR FOOD PREPARATION AND WARMING

(71) Applicant: Culinex Inc., Westminster, MD (US)

(72) Inventors: Carolyn J. WESCOTT, Crownsville, MD (US); Richard M. VALWAY, II, St. Petersburg, FL (US); Richard S. BARNES, Reunion, FL (US); Harry Edward BELSINGER, JR., Forest Hill, MD (US); Cyrus Robert ETEMAD-MOGHADAM, Fallston, MD (US); Handerson F. GOMES, Pittsburgh, PA (US); Andrew D. GRZANKA, Cockeysville, MD (US); Melissa S. KOVACH, Delmont, PA (US); Trevorne Q. NISBETT, Rosedale, MD (US); Laura K. ROCKS, Jarrettsville, MD (US); Joseph F. SHOEMAKER, Delta, PA (US); John Jerrod TRACY, Oronogo, MO (US); Yinan YANG, Chadds Ford, PA (US)

(73) Assignee: Culinex Inc., Westminster, MD (US)

(21) Appl. No.: 19/427,551

(22) Filed: Dec. 19, 2025

Related U.S. Application Data
(60) Provisional application No. 63/737,480, filed on Dec. 20, 2024.

(51) Int. Cl. A47J 39/00; H05B 3/68

(52) U.S. Cl. CPC A47J 39/00; H05B 3/68; H05B 2203/005; H05B 2213/07

(57) ABSTRACT

Disclosed herein are system, apparatus, article of manufacture, method and/or computer program product embodiments, and/or combinations and sub-combinations thereof, for managing food preparation. An example food warming device embodiment includes heating zones each having a thermally conductive heater plate, a temperature sensor; and a food presence sensor. Control circuitry of the food warming device independently drives the heater plates of the respective heating zone according to different heating profiles of food items loaded in the heating zones as directed by a user interface of a terminal. The terminal gives loading instructions according to a scheduled food preparation menu, and activates different visual indicators on the food warming device associated with the different heating zones to indicate which heating zones should be loaded with food items. The terminal commands the control circuitry to control heating of the respective heating zones according to the different heating profiles.

### CROSS-REFERENCE TO RELATED APPLICATION

This non-provisional application claims the benefit of U.S. provisional Ser. No. 63/737,480 , filed Dec. 20, 2024, the content of which is herein incorporated by reference.

### BACKGROUND

Effective food service solutions are crucial in the healthcare sector, especially for senior centers and similar facilities. However, conventional food preparation and heating systems often fail to meet the specific needs of residents and facilities due to several limitations. First, conventional systems often struggle with quick meal preparation, serving large numbers of meals efficiently, and minimizing energy use. Second, conventional systems often do not adequately ensure the safe handling of heated food items during distribution. Third, conventional systems often struggle to maintain the safety and quality of prepared meals, including taste and texture, the latter being a key problem with microwaved food. Fourth, conventional systems often fall short in consistently meeting long-term dietary requirements, resident preferences, and facility operational constraints such as budget, inventory, and preparation time. Finally, conventional systems may require trained kitchen staffing with associated costs and/or high turnover issues.

### BRIEF DESCRIPTION OF THE DRAWINGS

The accompanying drawings are incorporated herein and form a part of the specification.

FIG. 1 is a block diagram of a food preparation environment, according to some embodiments.

FIG. 2 is a perspective view of a food warming device that utilizes a heating system that ensures that food items are brought to, and kept at, the ideal temperature until serving time, according to some embodiments.

FIG. 3 is a perspective view of two shelves of a food warming device, according to some embodiments.

FIG. 4 is a block diagram of a heating zone of food warming device, according to some embodiments.

FIG. 5 is a flowchart illustrating a process for food warming, according to some embodiments.

FIG. 6 is a block diagram of a menu generation system, according to some embodiments.

FIG. 7 is a flowchart illustrating a process for generating a personalized meal plan that optimally satisfies various competing demands, according to some embodiments.

FIG. 8 is an example computer system useful for implementing various embodiments.

FIGS. 9-13 are user interface screens of an example terminal user interface, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for managing food preparation, from food selection to being ready to serve to consumers. Embodiments herein solve various technological problems associated with conventional food preparation and heating systems. First, embodiments herein provide more efficient heating (e.g., reheating) of food. In particular, embodiments herein decrease the time needed for a meal to be ready for eating, increase the number of meals ready for eating per unit of time (i.e., higher throughput), and decrease energy usage. For example, embodiments herein provide an improved load sequence of food items into food warming devices, thereby improving the time to load for staff while also reducing errors with checks to ensure that the proper food items are loaded in the food warming devices (e.g., that the proper food items are loaded into proper corresponding heating zone bays of the food warming devices). Second, embodiments herein increase operator safety by ensuring food items can be safely retrieved and consumed from a food warming device (e.g., ensuring the food item is not too hot to be handled). Third, embodiments herein ensure food safety while maintaining food quality of heated food items. In particular, embodiments herein ensure that a food item has undergone sufficient heating (e.g., reheating) to destroy potentially harmful bacteria and other microorganisms, which makes food safe to eat and easier to digest. At the same time, embodiments herein ensure that the food item has not undergone unnecessary heating that is harmful to human health, makes the food item harder to metabolize, or decreases the quality of taste or the quality of texture of the food item. Embodiments herein also ensure that meals and the food items they contain meet dietary requirements for the respective consumers. Finally, embodiments herein improve the generation of menu plans that better satisfy various competing demands, including user food preferences, user dietary restrictions, user nutritional goals, budget constraints, food inventory constraints, food preparation time, and facility constraints. This improvement in the generation of menu plans that better satisfy various competing demands also reduces the workload on dietitians and food service directors to prepare meal plans.

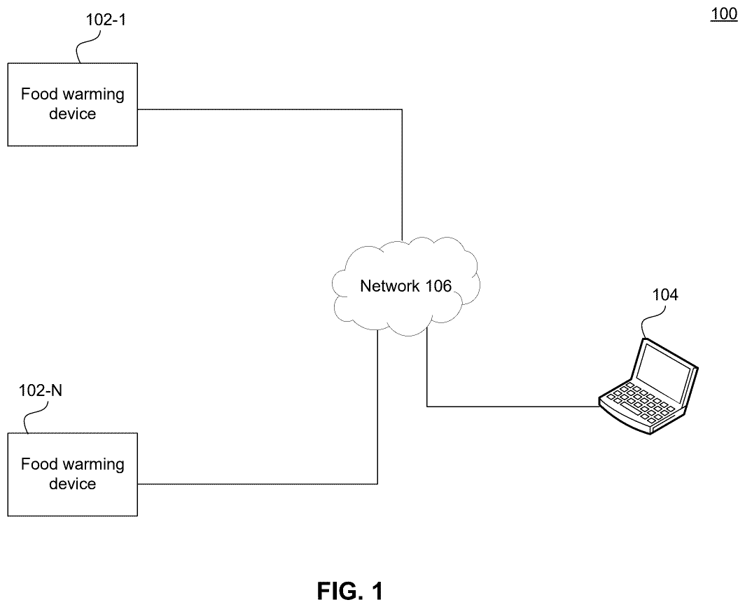

Various embodiments of this disclosure may be implemented using and/or may be part of food preparation environment 100 shown in FIG. 1. Food preparation environment 100 is provided solely for illustrative purposes, and is not limiting. Embodiments of this disclosure may be implemented using and/or may be part of environments different from and/or in addition to the food preparation environment 100, as will be appreciated by persons skilled in the relevant art(s) based on the teachings contained herein. An example of the food preparation environment 100 is now described.

FIG. 1 illustrates a block diagram of a food preparation environment 100, according to some embodiments. In a non-limiting example, food preparation environment 100 may be a facility that serves meals to many consumers such as a nursing home, memory care center, hospital, senior center, prison, school, or other facility as would be appreciated by a person of ordinary skill in the art. However, this disclosure is applicable to any type of food preparation environment.

The food preparation environment 100 may include one or more food warming devices 102-1 through 102-N (referred to herein in the singular as food warming device 102) and one or more terminals 104. A food warming device 102 (alternatively referred to as a heating appliance) is a food warming appliance that may utilize a heating system that can ensure that food items are brought to, and kept at or within, an ideal temperature or temperature range (e.g., a temperature or temperature range at which the heated food items are safe to handle for staff, safe to eat for consumers/residents, and/or not overheated, preserving the taste and texture) until serving time. A food warming device 102 can plug into a standard alternating current (AC) electrical wall outlet, as an example. A food warming device 102 may use a heating system that heats the same number of food items as, but consumes less energy than, a microwave oven.

A terminal 104 may utilize operations software to guide effective and/or efficient food preparation using the one or more food warming devices 102. A terminal 104 may coordinate the effective and efficient reheating of one or more food items in the one or more food warming devices 102. For example, a terminal 104 may guide a staff member to scan a sealed food item, load it as directed into the appropriate area of a food warming device 102, and alert the staff member when the heated food item is ready to serve (e.g., safe to handle by the staff member, safe to eat for the consumer/resident, and/or not overheated, preserving the taste and texture). A terminal 104 may also improve or optimize various other aspects of food preparation, including energy-efficient cooking and preparing multiple food items at once. A terminal 104 may also offer an easy-to-use system for consumers or staff to plan meals over time, ensuring meal plans consistently meet long-term dietary needs, resident preferences, and facility constraints like budget, inventory, and preparation time. For example, a terminal 104 may offer an easy-to-use system that ensures meals prepared at food preparation environment 100 align with the Academy of Nutrition & Dietetics (AND) Nutrition Care Manual and/or the International Dysphagia Diet Standardization Initiative (IDDSI) prescribed diet and nutrition interventions as ordered for a particular patient or resident receiving the prepared meal.

A terminal 104 may be any type of computing system, including a desktop workstation, laptop or notebook computer, netbook, tablet, smart phone, personal digital assistant (PDA), smart watch or other wearable, appliance, part of the Internet-of-Things (IoT), and/or embedded system, to name a few non-limiting examples, or any combination thereof.

The one or more food warming devices 102 and the one or more terminals 104 may be communicatively coupled via network 106. Each food warming device 102 may be configured to communicate with network 106 via a communication device. The communication device may include, for example, a router or a cable modem or satellite TV transceiver. The food warming device 102 may communicate with the communication device over a link, wherein the link may include wireless (such as Wi-Fi®) and/or wired connections.

In various embodiments, the network 106 can include, without limitation, wired and/or wireless intranet, extranet, internet, cellular, Bluetooth®, infrared, and/or any other short range, long range, local, regional, global communications mechanism, means, approach, protocol and/or network, as well as any combination(s) thereof.

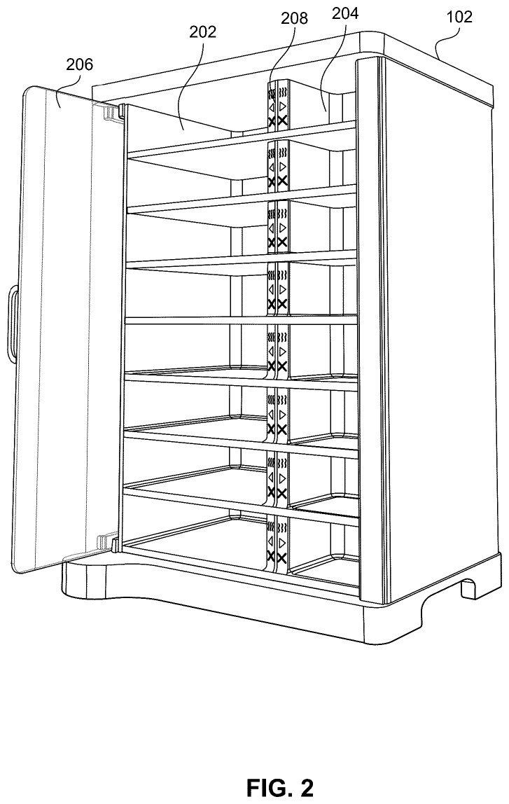

As described in greater detail below with regard to FIGS. 2 through 4, the heating system of a food warming device 102 can comprise independently controlled heating zones, each heating zone being configured to heat a food item (e.g., entree package, platter, or side dish). Each of the one or more food warming devices 102-1 through 102-N can further comprise control circuitry (not shown in FIG. 1) configured to control the temperature of the heating system, e.g., of each of the independently controlled heating zones. For example, in some embodiments, one or more of the food warming devices 102-1 through 102-N (or each food warming device 102) can comprise a central computer configured to control the temperature of the heating system, e.g., of the independently controlled heating zones. In other embodiments, one or more of the food warming devices 102-1 through 102-N (or each food warming device 102) can be configured without a central computer, and can instead receive control signals from a terminal 104 to direct the control circuitry to set, and vary with time, target temperatures of the heating system, e.g., of the independently controlled heating zones. One or more of the food warming devices 102-1 through 102-N (or each food warming device 102) can further comprise one or more temperature sensors (not shown in FIG. 1) and/or one or more food presence sensors (not shown in FIG. 1), which can provide feedback signals to the control circuitry (e.g., central computer) of the food warming device 102 and/or the terminal 104 useful for controlling the temperature of the heating system, e.g., of the independently controlled heating zones.

The food warming device 102 can further include an airflow path (not shown) and one or more fans (not shown) in the airflow path configured to route cooling air to cool the control circuitry (e.g., central computer and/or one or more control boards, which may include temperature-sensitive components). For example, the control circuitry, which can be in the airflow path, can include a control circuitry temperature sensor, and based on the measured temperature of the control circuitry exceeding a threshold, the control circuitry can activate and/or control the speed of the one or more fans to move air through the airflow path and over the control circuitry to help cool the control circuitry. The food warming device 102 can further include one or more fan filters (not shown) in the airflow path placed to be user-accessible and user-cleanable. For example, the fan filter(s) can be placed at an air intake of the airflow path. The air intake can be located on the food warming device 102 so that it does not pull in exhausted warm air from the food warming device 102. As one example, the food warming device 102 can be configured to exhaust warm air at the back of the food warming device 102, and to pull fan intake air from nearer the front of the food warming device 102. The airflow path can comprise one or more airflow conduits configured to route cooling air from one fan to the control circuitry (e.g., to each of a plurality of control boards) without circulating cooling air through any of the heating zones. The design of the fan can be selected to provide sufficient airflow for cooling while also limiting the fan noise produced.

By way of example, and not limitation, food preparation environment 100 may operate as an end-to-end food preparation solution for a facility such as a senior center, prison, school, behavioral health unit (a healthcare facility providing services for addressing mental health and/or substance abuse issues), or other facility that serves meals to large number of consumers (e.g., more than ten consumers).

In some example uses of the food preparation environment 100, food items may be prepared off-site (e.g., at a location outside of food preparation environment 100) according to meal specifications established by an entity's (e.g., company's) culinary team (e.g., dietitians and chefs). Each food item can be, for example, a plate or dish having one or more prepared foods. As one example, an entree food item can include a protein food (e.g., chicken, beef, pork, etc.) and a starch food (e.g., rice, mashed potatoes, pasta, etc.). As another example, an entree food item can include a protein food, a starch food, and a vegetable food. As yet another example, a side dish food item can include a vegetable food, a starch food, or a heated dessert (e.g., cobbler or pie). Each food item can be made individually packaged (e.g., plated) for easy insertion into a bay of a food warming device 102. The prepared food items may then be delivered to the location of the food preparation environment 100 and temporarily stored in cold storage of the location of the food preparation environment 100 (e.g., in one or more refrigerators or freezers) until a meal heating time shortly before a meal service time (e.g., an hour before a meal service time). One or more users (e.g., one or more staff members) at the food preparation environment 100 can utilize a terminal 104 to calculate how many food items are required to meet feeding demands of consumers (e.g., residents, patients, or other types of consumers as would be appreciated by a person of ordinary skill in art) for a fixed period of time (e.g., the next week or the next two weeks). A terminal 104 can then generate food item orders that are placed with the entity's (e.g., company's) food distribution partners for fulfillment. The terminal 104 can calculate the total food item need based on a menu and/or the clinical and/or personal needs of consumers (e.g., residents, patients, etc.). The system can also accommodate extra meals for staff or guests, and then calculate when to place the order for just-in-time delivery.

When food items are delivered, users (e.g., staff) at the food preparation environment 100 can receive the food in cases of sealed food items (e.g., as entree packages, platters, and/or side dishes) that can be immediately moved to cold storage of the location of the food preparation environment 100. The quantities of delivered food can be entered into a terminal 104 directly, using a mobile device, scanner, or other type of device as would be appreciated by a person of ordinary skill in art.

On meal service days, users (e.g., staff) in the food preparation environment 100 may obtain meal selections from consumers (e.g., residents, patients, etc.) that are entered directly into a terminal 104, a mobile device, or type of device as would be appreciated by a person of ordinary skill in the art.

Users (e.g., staff) can also rely on a terminal 104 to automatically make selections on behalf of consumers (e.g., resident, patients, etc.) by using various algorithms that account for each individual consumer's clinical requirements and/or personal preferences (or some combination thereof).

In combination with the one or more food warming devices 102-1 through 102-N, the terminal 104 can support meal preparation for specific consumers, or meal preparation for a population of a given size and given diet types but without specifics as to which individual consumers constitute the population (e.g., preparation of twenty-four meals, four of which are for vegetarians, with no specifics as to which consumer will consume which meal). The terminal 104 and food warming devices 102-1 through 102-N can thus support meal preparation operations in facilities that have frequent (e.g., daily) population turnover such that there may be insufficient time to enter names (or other identifiers) and consumer personal profiles into the terminal 104 for the individual consumers for whom food will be prepared.

A terminal 104 can instruct users (e.g., staff) in each food preparation environment 100 how much of each food item to acquire from central storage and/or to stage for food production for each meal and/or snack period. In some examples, food items may be brought to the heating location arranged on sealed plates designed to look and feel like normal dinner plates.

A terminal 104 may present countdown timers to alert users (e.g., staff) when to start loading one or more heating appliances 102-1 through 102-N. During loading, a terminal 104 can use various algorithms to determine which food items to load when in support of either bulk food loading or loading based on individual consumer orders.

Food items may be loaded based on prompts from a terminal 104. As an example, the terminal 104 can display a first prompt indicating a first number of first identical food items to load, accompanied by indications displayed on corresponding first one or more heating zones of the one or more heating appliances 102-1 through 102-N indicating the heating zones to be loaded with the first number of first identical food items. The display of the first prompt can be followed thereafter (e.g., after a confirmation input from a user, such as clicking or touching a “next” button, or after the one or more heating appliances 102-1 through 102-N have automatically detected loading of the corresponding heating zones) by a display of a second prompt indicating a second number of second identical food items to load, accompanied by indications displayed on corresponding second one or more heating zones of the one or more heating appliances 102-1 through 102-N indicating the heating zones to be loaded with the second number of second identical food items, and so on. This guided loading procedure, as coordinated by the terminal 104, can continue either until all food items to be heated for the meal or snack period have been loaded, or until the one or more heating appliances 102-1 through 102-N have been loaded to capacity, in which case the guided loading procedure can resume as heating zones become available. For example, the terminal 104 can display a first message such as “Load six chicken Alfredo items” and can command the lighting of indicators on six corresponding heating zones of a heating appliance 102. After the user has loaded these six heating zones, the terminal 104 can display a second message such as “Load three beef items” and can command the lighting of indicators on three corresponding additional heating zones of the heating appliance 102, and so on. As described in greater detail below, the terminal 104 and/or a heating appliance 102 can indicate a loading error when the heating appliance 102 detects that food was loaded into an incorrect zone.

After all specified items are loaded, a user interface of the terminal 104 can indicate loading is complete. In some embodiments, the user interface of the terminal 104 can further provide an image or other visual representation of the one or more heating appliances 102-1 through 102-N that displays the heating status for each heating zone and the time when the first zone will complete the heating cycle. In some embodiments, the user interface of the terminal 104 can display a countdown timer for each heating zone.

In some examples, food items may be scanned using a scanner to identify each item being loaded based on a barcode, QR code, or other identifying information as would be appreciated by a person of ordinary skill in the art. For example, the terminal 104 can direct a user to individually scan each food item (e.g., using a handheld or mounted barcode or QR code scanner) before loading the scanned food item into a corresponding heating zone. The terminal can thereby provide error control, e.g., by signaling to a user when an incorrect food item has been picked for loading, and/or food item inventory control, e.g., by decrementing from a standing food item inventory count (e.g., held in a memory of the terminal 104) each food item as it is scanned. In other examples, each heating zone can comprise a sensor that performs the scanning to ensure that the correct food items are loaded into the correct heating zones. Other embodiments may omit such food item scanning, in which cases, inventory adjustment may be automatically performed based on items instructed to be loaded by the terminal 104.

The system may allow communication between a terminal 104 and a food warming device 102 to identify which heating zone (e.g., heating zone 202 or 204) to load each food item into with corresponding visual cues (visual indicators) presented on the terminal 104 and/or the food warming device 102. A food warming device 102 can receive, from the terminal 104, a heating profile for a specific heating zone, and can execute the heating profile when it detects an item being placed in that zone. The food warming device 102 can continue monitoring to make sure that the food item is not removed from the designated heating zone prematurely.

A heating profile for each type of food item may determine the heating strategy and/or cycle for each heating zone (e.g., heating zone 202 or 204) in the food warming device 102, which can result in food coming to a temperature slowly with the ability to be held at a final heating temperature for a prolonged period of time. A heating profile can, for example, comprise one or more functions of temperature of a heating zone with respect to time for one or more heating phases (e.g., a preheating phase, a heating phase, a holding phase, etc.), and can be stored, for example, in a memory of a terminal 104 as a two-dimensional array of values (or multiple sets of such arrays, such as one set for each heating phase) comprising time values and associated temperature values. The time values can, for example, be relative time values as measured from a start of a phase of a heating procedure. The start of a heating procedure can be, in different examples, a start of a preheating phase (prior to loading of a food item into a heating zone), a start of a heating phase (after the food item is loaded into the heating zone), or a start of a holding phase (after the food item has been heated to serving temperature). In some embodiments, a heating profile can omit a pre-heating phase and/or can omit a holding phase.

The heating phase can be configured to bring a food item (e.g., a previously cooked and subsequently refrigerated or frozen food item) to a temperature of lethality that is of sufficiently high temperature to kill harmful pathogens (e.g., bacteria or other microorganisms) present in the food item. The holding phase can be configured to keep the food palatably warm or hot without, for example, denaturing the starch content or nutrient content of the food item by holding the food item at too high of a temperature for too long. In general, once the temperature of lethality is reached for a sufficient amount of time during the heating phase, the holding phase can involve a decrease in temperature from the temperature of lethality to maintain nutrition and palatability. The heating phase can further be configured not to reach sufficiently high temperatures for sufficient lengths of time so as to cook (or re-cook) the food item. In contrast to merely reaching a temperature of lethality capable of killing pathogens, cooking results in a functional change to the food item using heat application. The distinction between cooking and heating can be dependent on the food item. Accordingly, embodiments as described herein beneficially allow for temperature profiles stored and carried out that are customized to the individual food items heated using the food warming device 102. Moreover, embodiments as described herein can advantageously notify the user when a food item has been held out in a holding phase for too long and should therefore be considered expired.

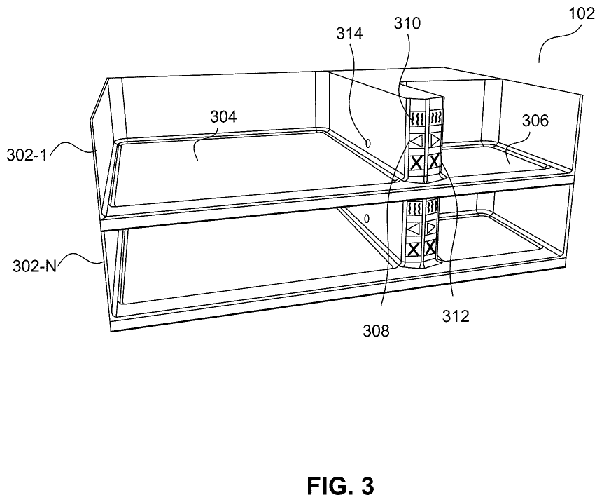

In some embodiments, heating profiles can be entirely time-dependent, and may not rely on other data inputs, such as inputs from a food presence sensor 408 or a temperature sensor 406. In some embodiments, heating profile can further comprise logic that can define the intended heating behavior of a corresponding heating zone, such as triggers between heating phases or instructions to hold a heating phase at a certain temperature indefinitely. In accordance with such logic, different phases of a heating profile may begin or end based on factors other than elapsed time, such as based on a determination of food item loading or unloading as determined by a food presence sensor, or such as based on a determination of a heating element having reached (or not having reached) a certain temperature, both of which are described in greater detail below with regard to FIG. 3. As one example, a food heating phase of a heating profile may be configured not to begin until after a detection of a food item having been loaded into a respective heating zone, irrespective of any amount of elapsed time in a corresponding preheating phase of the heating profile. As another example, a food heating phase of a heating profile may be configured not to begin until after a detection of a certain temperature having been attained in a respective heating zone, irrespective of any amount of elapsed time in a corresponding preheating phase of the heating profile. As still another example, a holding phase of a heating profile may be configured not to begin until after a detection of a certain temperature having been attained in a respective heating zone, irrespective of any amount of elapsed time in a corresponding heating phase of the heating profile. As yet another example, a holding phase of a heating profile may be configured to continue indefinitely, irrespective of any amount of elapsed time in the holding phase.

In some embodiments, a heating profile can be configured to include a time limit per heating phase. For example, a heating profile can be configured to include a time limit of two hundred fifty minutes. Such time limits can be encoded in the heating profile and/or can be enforced by the terminal 104. In some embodiments, a heating profile can be configured to include a maximum number of heating phases. For example, a heating profile can be configured to include a phase limit of two hundred fifty-five heating phases. Such heating phase number limits can be encoded in the heating profile and/or can be enforced by the terminal 104. Heating profile time limits and phase number limits can provide safety and power expenditure efficiency advantages.

When meal service commences, after food items have been warmed, the terminal 104 can alert users (e.g., staff) that food is at service temperature. Similarly, the terminal 104 can match food items in each heating zone (e.g., heating zone 202 or 204) to the correct consumer (e.g., resident or patient) the corresponding food item is intended for. A terminal 104 can support bulk unloading to support buffet-style feeding and/or consumer-by-consumer food item unloading to support food delivery to tables or rooms.

The terminal 104 may further determine which food items are necessary to produce the next set of meals. The terminal 104 may generate a list of inventory items required to support the meal preparation, including, but not limited to, food plates, accessories, beverages, supplies, etc.

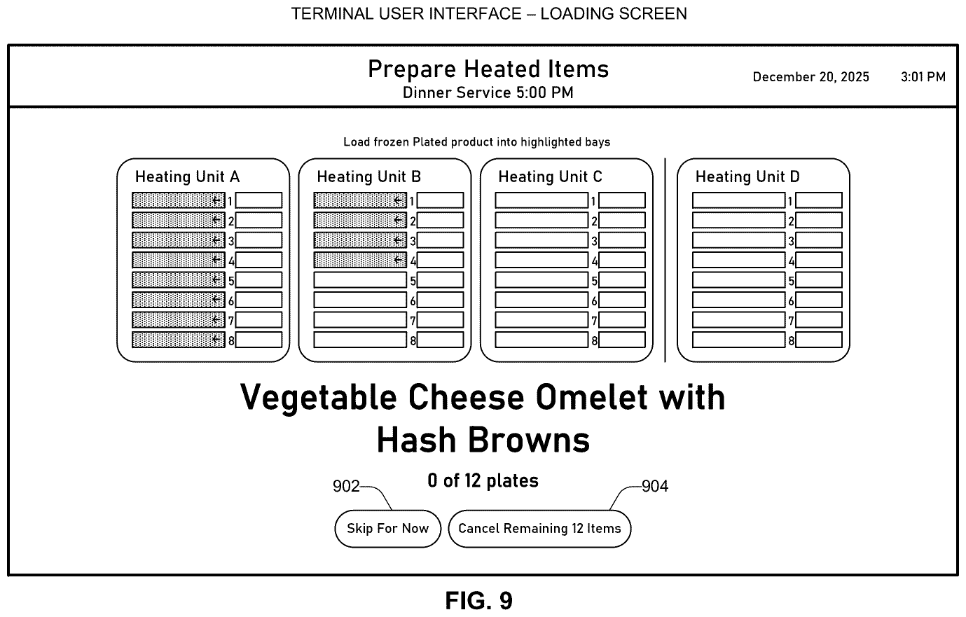

The terminal 104 can generate guidance on which food items to load into corresponding heating zone bays of the food warming device 102 depending on a focus for the food preparation environment. For example, the terminal 104 can generate guidance based on enhanced load time and/or enhanced de-load time. For example, the terminal 104 can instruct, via a user interface of the terminal 104, that all food items of a first type should be loaded, indicating a first set of bays of the food warming device 102 for loading of such food items via the user interface of the terminal 104, and can wait to determine that all indicated bays have been loaded with food items before moving on to instructing, via the user interface, that all food items of a second type should be loaded, in part by indicating a second set of bays of the food warming device 102. As an example, the terminal 104 can instruct to load all roast chicken plate food items before instructing to load all roasted vegetable plate food items, with the instructions indicating corresponding bays of the food warming device 102. FIGS. 9 through 12, described in greater detail below, show examples of such instructions and other information as presented by an example user interface of the terminal 104. As heated food items become ready to serve, notifications may be sent to the terminal 104 and/or devices may alert a user as to which heated food items are ready to serve.

The terminal 104 can manage hot and cold (e.g., refrigerated or room-temperature) food items. For example, when heating of a food item is complete, a user interface of the terminal 104 can display a ticket for a meal that can include names of one or more heated food items for a consumer, plus all of the room temperature and cold food items (e.g., salads, fruit, beverages, sandwiches) that may accompany the one or more heated food items to constitute an entire meal for the consumer. Additionally or alternatively to displaying the ticket on a user interface of the terminal 104, the terminal 104 can print a paper copy of the ticket for the consumer. For example, the terminal 104 can include or can be coupled to a receipt printer (not shown) that can be commanded by the terminal 104 to automatically print one or more meal tickets that facilitate matching food items (including heated food items and cold food items) with the one or more consumers who will receive the food items. Each printed ticket can list the one or more food items and the name or other identifier of the consumer. In some examples, each printed ticket can further list an eating location (e.g., a seat, table, dining area, or consumer's room number), service notes, consumer birthday notifications, nutrition summary data, and/or other consumer clinical data, consumer service data, or consumer personal data.

FIG. 2 illustrates a three-quarters perspective view of a food warming device 102 that utilizes a heating system that ensures that food items are brought to, and kept at, the ideal temperature (e.g., safe to handle for facility staff, safe to eat for consumers/residents, and/or not overheated, preserving the taste and texture) until serving time, according to some embodiments. FIG. 2 is discussed with reference to FIG. 1, although this disclosure is not limited to that example embodiment.

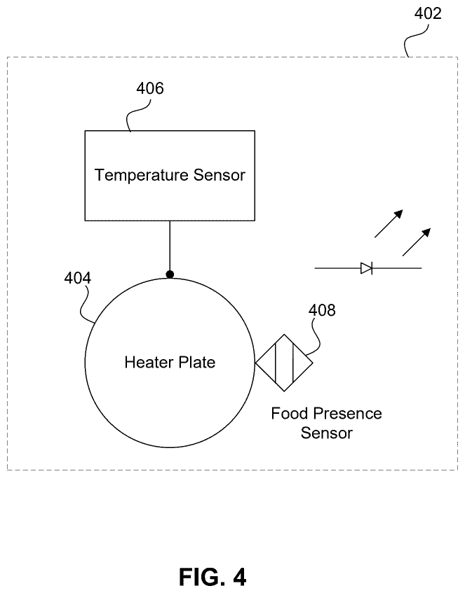

The food warming device 102 may include a housing (which may also be referred to as a cabinet or chassis, and is generally indicated in FIG. 2 by reference numeral 102), which may contain control circuitry (e.g., a central computer) (not shown in FIG. 2), one or more independently controlled heating zones 202 and 204, and a software-lockable door 206 to secure the food and stabilize the temperature. For example, the food warming device 102 may contain heating zones for a fixed number of entrees and side dishes (e.g., 16 independent heating zones for 8 entrees and 8 side dishes as illustrated in FIG. 2). As shown in FIG. 2, each heating zone may be separated from each other heating zone by walls, e.g., walls that provide some amount of thermal insulation, allowing the different heating zones to come to, and be held at, different temperatures. In the example food warming device 102 shown in FIG. 2, all heating zones are accessed by a single door 206, but in other examples, not shown, individual heating zones may have separate doors, or groups of heating zones may separate doors (e.g., an entree heating zone and a corresponding side dish heating zone may share a door). The food warming device 104 can be configured to primarily use conduction through respective heater plates (e.g., heater plate 404 in FIG. 4, described in greater detail below) to warm food items placed in the heating zones. The air temperature of each zone thus can be expected to be less warm than a set point specified by a heating profile, and the majority of the difference of temperature between heating zones may result from the separately controlled heater plates directly heating the food item placed on them. This configuration may advantageously reduce the amount of thermal insulation needed between heating zones within a food warming device.

The food warming device 102 may comprise a number of shelves (e.g., 8 shelves, as in the example illustrated in FIG. 2). A shelf of a food warming device 102 may contain an entree heating zone 202 and a side heating zone 204. Each heating zone may include a heater plate, a food detection sensor, and one or more indicators 208 that visually indicate the status of the food item (e.g., a load/unload food indicator, a warming/ready indicator, and a discard food indicator). Example indicators are described in greater detail below with regard to FIG. 3.

FIG. 3 illustrates a three-quarters perspective view of two shelves of a food warming device 102, according to some embodiments. FIG. 3 is discussed with reference to FIG. 1, although this disclosure is not limited to that example embodiment.

A food warming device 102 may contain one or more shelves 302-1 through 302-N (referred to herein in the singular as shelf 302). A shelf 302 may have one or more heating zones (e.g., heating zones 304 and 306) that warm a food item placed within it. For example, a shelf 302 may have a heating zone 304 for an entree food item and a heating zone 306 for a side dish food item. In the example illustrated in FIG. 3, the heating zone 304 for the entree food item has greater width (left to right on the shelf) and greater depth (front to back on the shelf) than the heating zone 306 for the side entree on the same shelf.

A shelf 302 may also include one or more visual indicators configured to visually indicate the status of corresponding heating zones or food items therein (e.g., a load/unload food indicator 308, a warming/ready indicator 310, and a discard food indicator 312). In some embodiments, the indicators comprise lights (e.g., light-emitting diodes) arranged as, or shone through, various shapes. In the illustrated example, the load/unload food indicator 308 is arranged as a triangle or arrow shape that points to a corresponding indicated heating zone of the food warming device 102, the warming/ready indicator 310 is arranged as a three-wavy-lines shape, and the discard food indicator 312 is arranged as an “X” shape. In other embodiments, the one or more indicators can be configured as video screens that can display animated indicators. The lighting and/or display of the one or more indicators can be controlled by a terminal 104 connected to the food warming device 102 via the network 106. For example, the terminal 104 can be programmed and/or configured with a food preparation schedule or plan that provides the timing of food item loading, warming, and unloading phases or tasks. Based on or in accordance with the schedule or plan, the terminal 104 can send signals to the food warming device 102 that command the lighting, unlighting, or display of various ones of the indicators. For example, when it is time to load food items of a first type, the terminal 104 can command lighting of load/unload food indicators corresponding to a first number of heating zones of the food warming device 102, and subsequently, when it is time to load food items of a second type, the terminal 104 can command lighting of load/unload food indicators corresponding to a second number of heating zones of the food warming device 102. Later, when the food items are ready to be served, the terminal 104 can command lighting of warming/ready indicators (or load/unload food indicators) corresponding to heating zones of the food warming device 102 for which the corresponding loaded food items are fully heated and ready to be unloaded and served. The lighting of the indicators can be made visually distinct for loading versus unloading. For example, a loading/unloading indicator may be made to be held on to indicate loading and may be made to flash to indicate unloading, or vice versa, or flashing of different duty cycles may be used, etc. In some embodiments, all of the indicators corresponding to a heating zone (e.g., as shown in FIG. 3) can be configured to be set to any color, steady or flashing, with the icon or pictograph represented by the indicator being of fixed shape.

The user interface of the terminal 104 can display a visual representation of one or more of the one or more food warming devices 102-1 through 102-N that graphically depicts individual heating zones and indicates respective loading and/or heating statuses of the individual heating zones. As one example, for every command issued by the terminal 104 to activate or adjust an indicator associated with a heating zone (e.g., load/unload food indicator 308, warming/ready indicator 310, discard food indicator 312), the user interface of the terminal 104 can display a corresponding representation (e.g., a color-coded representation or flash/blink-coded representation) of the heating zone. This functionality provides a notice (e.g., that food should be loaded or unloaded, or that other directed action should be taken) to be available both on the corresponding food warming device 102 and on the user interface of the terminal 104.

A heating zone (e.g., heating zone 304 or 306) may also include a food presence sensor 314 configured to detect the presence of a food item in the corresponding heating zone. For example, the food presence sensor 314 may be, but is not limited to, a motion sensor, a proximity sensor, a Hall effect sensor, a weight sensor, a pressure sensor, a switch, an optical sensor (e.g., a laser sensor or an infrared sensor), an acoustic sensor (e.g., an ultrasonic sensor or a sensor based upon a warming zone cavity's properties as a Helmholtz resonator), a barcode scanner, a camera, or other type of sensor as would be appreciated by a person of ordinary skill in the art. The food presence sensor 314 may be arranged within, underneath, or, as illustrated in FIG. 3, to the side of a heater plate of a warming zone. In some embodiments, one or more (or all) of the heating zones may exclude the food presence sensor 314, or a temperature sensor (as described below with regard to temperature sensor 406 in FIG. 4) may also serve in function as a food presence sensor. In the latter instance, for example, a detection of a sudden drop in temperature in a warming zone, as measured by a temperature sensor, may serve as an indication that a warming zone has just been loaded with a food item (e.g., a chilled or frozen food item) that has brought down the temperature of the warming zone.

FIG. 4 illustrates a block diagram of a heating zone of food warming device 102, according to some embodiments. FIG. 4 is discussed with reference to FIGS. 1-3, although this disclosure is not limited to that example embodiment.

A heating zone 402 (e.g., heating zone 304 or 306 in FIG. 3) may include a heater plate 404 in which a food item to be heated/reheated is placed. In some embodiments, the heater plate 404 can comprise a thermally conductive (e.g., aluminum) plate with a resistive electrical heating element bonded to the underside. In other embodiments, the heater plate 404 may comprise other types of heating elements of various materials and forms as would be appreciated by a person of ordinary skill in the art. For example, in some embodiments, the heater plate 404 can be an induction cooktop that heats by a magnetic field or an infrared radiator. In some embodiments, the heater plate 404 can be a mechanically stationary element (e.g., one that does not rotate or translate to convey itself or food that rests on it).

A heating zone 402 may also include a temperature sensor 406 for the heater plate 404. Each heating zone 402 may include its own temperature sensor 406 (e.g., a thermistor). The temperature sensor 406 can provide a temperature measurement that can act as feedback indicative of the temperature of the corresponding individual heating zone 402. This feedback allows each heating zone 402 to be independently adjusted to a temperature, or set of temperatures varied over time, that is customizable for the food that the heating zone 402 holds, such as an improved or optimal temperature, or set of temperatures varied over time, for the food held in the heating zone 402. For example, in some embodiments, the temperature sensor can provide a temperature measurement that can be used to trigger a transition between different phases of a heating profile, in accordance with logic associated with the heating profile, as described above. In other embodiments, the temperature sensor may be configured only to provide a closed-loop control for driving the heater plate 404, and the heating profile may transition between heating phases based on elapsed time alone.

The temperature measurement of the temperature sensor 406 can further be used to improve quality control of the heating process. As one example, a terminal 104 can be configured to correlate temperature measurements made during the heating process with post-heating data collected reflecting taste, texture, nutrition, digestibility, and/or wholesomeness, etc. of heated food items. As examples, heated food items can be chemically analyzed to determine their nutritional properties after being heated using an assigned heating profile, and/or taste and/or texture poll data can be collected from consumers eating the heated food items, and the terminal 104 can be configured to correlate temperature measurements made during the heating process with the results of the chemical analysis and/or the taste and/or texture poll data (or data derived from the taste and/or texture poll data). Such a process can be repeated for a number of same-type food items heating using various heating profiles (including, for example, variations of the holding phase of the heating profiles) so as to tune heating profiles for optimal taste, texture, nutrition, digestibility, and/or wholesomeness, etc., of heated food items.

As another example, control circuitry of the food warming device 102 can be configured to compare temperature measurements made during the heating process with expected temperatures as set forth in one or more heating profiles to ascertain whether or not a heater plate of a heating zone performs to within specified tolerances. For example, based the control circuitry of the food warming device 102 determining, during a cooking process, in view of the measured-versus-expected temperature comparison, that a heater plate of a heating zone is unable to come to within a tolerance range of the expected temperature(s) as set in the heating profile, or fails to come to within the tolerance range of the expected temperature(s) within expected time(s), the control circuitry of the food warming device 102 may ascertain that the heater plate is faulty and may automatically take the corresponding heating zone out of commission, e.g., by sending a notification message to the terminal 104 that results in the flagging the heating zone as underperforming within a memory of the terminal 104. A heater plate can be declared faulty in this manner based on the heater plate underheating or overheating. Based on recognizing a faulty heater plate in this manner, the terminal 104 can direct a user to move a food item loaded in the corresponding heating zone to a different heating zone for proper heating. For example, the terminal 104 can display a prompt on a user interface of the terminal 104, and/or can activate an indicator of a faulty heating zone (e.g., can cause a load/unload food indicator to blink and/or change to a color, such as red) and can activate an indicator of a substitute heating zone to guide the user to reload the food item into the substitute heating zone. Subsequently, and until a user override (e.g., after a repair to the heater plate), the terminal 104 can abstain from instructing loading of food items into the decommissioned heating zone. The terminal 104 can determine when a decommissioned heating zone and/or a substitute heating zone has been loaded or unloaded based on sensor feedback from food presence sensors of the respective heating zones. In some embodiments, the terminal 104 can account for faulty heating zones in one or more food warming devices 102 when calculating loading/unloading plans and instructions for a loading or unloading phase of food item preparation. Accordingly, a terminal 104 will ordinarily not direct a user to load a food item into a known faulty heating zone. The ability of the food preparation environment 100 to continue operating, with all non-faulty heating zones continuing to operate in spite of a food warming device 102 having one or more faulty heating zones, adds to overall system robustness and tolerance to failure.

As yet another example, based the terminal 104 determining, during a cooking process, in view of the measured-versus-expected temperature comparison, that a food item has not come to a serving temperature within an expected time, the terminal 104 can display an alert, via its user interface, informing a user that the food item loaded into a particular heating zone is not ready to serve (e.g., even if other food items loaded contemporaneously are ready to serve). This circumstance can occur even when a heating zone is not faulty, for example, based on a food item having been stored at a temperature substantially lower than expected (e.g., than for which the corresponding heating profile was developed). In any of the above examples, the terminal 104 and the temperature sensor 406 can provide quality control that prevents food items from being underheated or overheated, e.g., by a faulty heating zone or unexpected storage conditions, providing a level of quality control not available with conventional food heating systems.

A heating zone 402 may also include a food presence sensor 408 to detect the presence of a food item in the heating zone. For example, the food presence sensor 408 may be, but is not limited to, a motion sensor, a proximity sensor, a weight sensor, an optical sensor (e.g., a laser sensor or an infrared sensor), an ultrasonic sensor, a camera, or other type of sensor as would be appreciated by a person of ordinary skill in the art. In some examples, the food presence sensor 408, can measure a light reflectance distance to determine whether a heating zone cavity is empty or occupied by a food item. In some examples, the food presence sensor 408 can detect a visual code, such as a bar code or a QR code, on a surface of a food item to determine that a heating zone is occupied by the food item. Feedback from the food presence sensor 408 to the terminal 104 can indicate, for example, that a food item has been loaded into an incorrect heating zone. For example, in a circumstance wherein the terminal 104 instructs, e.g., via a display on its user interface, that a user should load food items into specified heating zones as indicated by load/unload food indicators of the specified heating zones, but the user misloads one or more of the food items into a non-specified heating zone, the one or more food presence sensors of the respective one or more misloaded, non-specified heating zones can indicate the misleading to the terminal 104, and the terminal 104 can accordingly notify the user of the food item loading error(s) and direct the user, e.g., through a display of one or more prompts on the user interface of the terminal 104 and/or through indicators of the misloaded heating zones, to correct the loading error(s). For example, the terminal 104 can direct the load/unload food indicators of any misloaded heating zones to blink and/or to light a certain color (e.g., red).

In some embodiments, each shelf of a food warming device 102 can have its own control circuitry (e.g., its own circuit board) to provide independent temperature control to its corresponding two heater plates of its two warming zones (e.g., one for an entree and one for a side dish). For example, each circuit board can have a microprocessor. The control circuitry can provided independent heating profile control to its two respective warming zones, such that they can be independently temperature-controlled. Providing a separate microprocessor for each shelf can enhance scalability and robustness to failure of the food warming device 102. The shelves of the food warming device 102 can be modularly removable and swappable for enhanced maintenance. Additionally, the food warming device 102 can have control circuitry communicatively coupled to the control circuitries (e.g., the circuit boards) of the shelves in the food warming device 102.

For each food item, a specific heating profile can be applied to a heating zone 402 to optimize the reheating cycle. Each heating zone 402 can be started independently. For example, a heating zone 402 can be started when a corresponding food presence sensor 408 is triggered, thereby allowing flexible food preparation. Heating profiles for different corresponding heating zones can be managed by a terminal 104 and sent to a food warming device 102 when one or more food items are loaded into one or more respective heating zones of the food warming device 102.

By way of example, and not limitation, during preparation of food at food preparation environment 100, a user (e.g., a staff member at food preparation environment 100) at a terminal 104 can control each of the one or more food warming devices 102, with a terminal 104 serving as a single point of control for each of the one or more food warming devices 102 on the network 106. The user can control each of the one or more food warming devices 102 at the terminal 104 using a user interface such as, but not limited to, a touch screen user interface.

The use of a single terminal 104 to control multiple food warming devices 102 on the network 106 can facilitate scaled food production. In particular, the terminal 104 can use various resource allocation strategies to ensure optimal or improved use of the multiple food warming devices 102 (e.g., maximization or increasing of the number of food items served per unit time, minimization or decreasing of energy usage of the food warming devices, etc.). The terminal 104 can independently control each food warming device 102 as well as a particular heating zone (e.g., a heating zone 402) within each food warming device 102 using a unique network protocol (e.g., a network protocol implemented in the data section of an Open Systems Interconnection (OSI) Layer 2 protocol).

The terminal 104 can maximize or increase utilization by issuing commands to the one or more food warming devices 102-1 through 102-N and/or by displaying loading/unloading directives to a user interface of the terminal 104. In addition to managing loading for a given meal period, the terminal 104 can concurrently manage loading of additional items for late service. The terminal 104 can also calculate a number of heating zones needed for an upcoming meal period and determine if there are sufficient heating zones to accommodate all of the meals to be prepared in the upcoming meal period. For example, based on the terminal 104 determining that an insufficient number of heating zones are available to accommodate all of the food items to be prepared in the upcoming meal period, the terminal 104 can display an alert to a user interface of the terminal 104, and/or can transmit one or more alert notifications to one or more other devices (e.g., smartphones or other mobile devices). Further, based on the terminal 104 determining that leftover food items from a prior service period remain in heating zones, the terminal can display one or more directives on the user interface (and/or transmit mobile alert notifications) to guide a user (e.g., staff) to selectively remove one or more of the leftover food items from their heating zones to make sufficient room to heat the food items for the upcoming meal service. Similarly, if heating is in process and a user (e.g., staff) attempts to add an extra food item, the terminal 104 can validate that there is sufficient time to heat the extra food item prior to the upcoming meal period. Based on the terminal 104 determining that there is insufficient time to heat the extra food item prior to the upcoming meal period and that, as a result of attempting to heat the extra food item, there will be insufficient number of available heating zones to heat all of the food items for the upcoming meal period, the terminal 104 can display a directive to the user interface of the terminal 104 not to heat the extra food item and/or can decline to issue a command to the appropriate food warming device 102, e.g., that would unlock a door 206 or that would initiate heating of the extra food item, thereby advising against or preventing loading and/or heating of the extra food item. In such a case, the terminal 104 can further display advice on the user interface guiding the user (e.g., staff) to offer an alternate cold food item, such as a salad or a sandwich.

The terminal 104 can control a food warming device 102 by issuing commands to the unique network address of the food warming device 102. Additionally, the terminal 104 can control a particular heating zone (e.g., a heating zone 402) within the food warming device 102 by issuing commands according to a unique internal addressing scheme that specifies each internal component of the food warming device. For example, the terminal 104 can transmit a network frame to the food warming device 102 that specifies that the command applies to particular internal component such as, but not limited to, a heater plate (e.g., heater plate 404), a temperature sensor of a heater plate (e.g., temperature sensor 406), a food presence sensor (e.g., food presence sensor 408), an indicator that provides the status of a food item (e.g., one or more of indicators 208), or a door lock.

The terminal 104 may issue various commands to a food warming device 102. For example, the terminal 104 may send a status command to food warming device 102 to get the current state of the food warming device 102 (e.g., a measured temperature of any one or more of the heating zones of the food warming device 102, a food item presence indication of any one or more of the heating zones of the food warming device 102, or a door lock status for a door 206 of the food warming device 102). The terminal 104 may also send a status command to a particular target component of the food warming device 102 (e.g., a shelf, a heater plate, a door lock, etc.) and the food warming device 102 can send back to the terminal 104 the state of the target specified in the command.

The terminal 104 may also send a set state command to the food warming device to set the current state of the food warming device 102. Similarly, the terminal 104 may send a set state command to a particular target component of the food warming device (e.g., a shelf, a heater plate, a door lock, etc.) and the food warming device 102 can change the state of the target specified in the command to the state indicated.

The terminal 104 may also send a serving command to the food warming device 102 to indicate that a food item in the specified heating zone (e.g., a heating zone such as heating zone 304 or 306) needs to be removed.

The terminal 104 may also send a heating profile command to a heating zone (e.g., heating zone 304 or 306) in the food warming device 102, thereby causing the food warming device 102 to start a heating process in the indicated heating zone according to an associated heating profile, to change a phase of the heating process, to set a particular temperature, etc. The heating profile command may specify a heating zone in the food warming device (e.g., first shelf, first side heater). For example, the heating profile command may specify the heating zone using the unique internal addressing scheme discussed above. The heating profile command may also specify a heating profile to be utilized for the indicated heating zone. As an example, the heating profile may specify a preheat time, a preheat temperature, a heating time, a heating temperature, a holding time during which the food item is ready to serve and after which the food item should be considered expired, and one or more holding temperatures to use for the heater plate in the heating zone. As another example, the heating profile may specify a set of preheat temperatures with respect to time for a preheat phase, a set of heating temperatures with respect to time for a heating phase, and a set of holding temperatures with respect to time for a holding phase, along with associated logic that can control transitions between phases or repetitive cycling of phases (e.g., a holding phase may be cycled, with a pulsing temperature, either until an expiry time or indefinitely). A heating profile may specify a large number of phases over the course of the heating profile (e.g., 255 different phases). The terminal 104 may select the heating profile for the heating zone based on the particular food item and/or known storage conditions (e.g., refrigerated or frozen) being placed in the heating zone (e.g., heating zone 402). Accordingly, each type of food item stored under each storage condition may have its own corresponding heating profile. For example, a food item of one type stored as frozen may have a different heating profile from a food item of the same type stored as refrigerated (at a higher temperature than frozen).

Different heating profiles may also be elected (e.g., automatically by a terminal 104) based on whether the food being prepared is an “anytime service” meal that might be served at any time versus a “scheduled service” meal for feeding the bulk of the population. As examples, a food preparation schedule with which the terminal 104 is programmed may specify anytime service or scheduled service for a food preparation session, or a user input to a user interface of the terminal 104 may specify a choice of anytime service or scheduled service for the food preparation session. Based on this specification of service type, the terminal 104 may automatically choose a heating profile for the food items to be prepared. For example, an anytime service heating profile may specify a different holding phase than a scheduled service heating profile for the same food item stored under the same conditions.

A heating profile 402 may define the time required for a food item to be ready to serve and/or the food ready indicator (e.g., warming/ready indicator 310) to be lit. When the food has reached its limit of heating for safety or quality reasons, the food expired indicator (e.g., discard food indicator 312) can be lit. For example, the heating profile can define a maximum amount of time in a holding phase or a maximum number of pulsing cycles of a holding phase, after which the food can be declared expired and the discard food indicator 312 can be lit.

A holding phase can be customized to maintain food quality and palatability over longer periods of time. In some examples, after a heating phase of a heating profile, a food item can be held at a constant temperature during a holding phase. In other examples, a holding phase in a heating profile can specify a pulsed temperature, e.g., cycling between two or more target temperatures. A food item may have a temperature “danger zone” wherein, when the food item is held in the danger zone for too long, food quality is more quickly degraded. Conversely, starch in a food item can become resistant to digestion when food is cooled after warming in a process called starch retrogradation, which can reduce food quality. Accordingly, a pulsed holding phase can be designed to periodically reduce heating zone temperature to keep the food item from being in the danger zone for too long, but without excessive cooling that would cause substantial starch retrogradation in the food item. Thus, a pulsed holding phase can permit the food item to be held longer, while maintaining food quality, as compared to a holding phase with a static target temperature, and the heating profile can take this longer hold time into account, delaying the signaling of expired food (e.g., via discard food indicator 312), potentially reducing food waste.

The ability of each individual heating zone 402 to operate independently can allow flexibility in heating different food items with different heating requirements simultaneously as compared to heating food items in a large warming oven in which everything may be heated at the same temperature. Once a menu is established, the food items can be scheduled and loaded so that they are ready to be served at a scheduled time based on the individual heating profiles and/or appropriately staggered start times as further discussed below. For example, a terminal 104 can be programmed with a food preparation schedule and can coordinate food preparation, instructing users (e.g., staff) to load certain heating zones of the food warming device 102 with certain food items, and automatically warming the items according to their individual heating profiles, according to the food preparation schedule.

Embodiments herein solve the above-mentioned technological problems associated with conventional food preparation and heating systems using a combination of unique features. First, embodiments herein ensure efficient reheating of food items using a terminal 104 that can independently control particular heating zones in each of the one or more food warming devices 102. For example, the terminal 104 can use various resource allocation strategies to ensure optimal use of the multiple food warming devices 102 (e.g., maximization the number of meals served per unit time, minimization of energy usage, etc.). Similarly, the terminal 104 can use various resource allocation strategies to ensure improved or optimal use of the particular heating zones within the food warming device 102. Because of the interactions between a food warming device 102 and a terminal 104, and the understanding held by the terminal 104 of what food item is in which heating zone, the food preparation environment 100 can be capable of autonomously managing the transitions between warming and holding in a plurality of different heating zones, and to manage such transitions differently for different heating zones to accommodate the potentially different food items, and/or food items having different warming start times, loaded in the different heating zones.

Additionally, embodiments herein can ensure efficient reheating of food items through the utilization of a particular heating profile for a heating zone (e.g., heating zone 304 or 306) based on the particular food items being placed in the respective heating zones. The utilization of the heating profile in this manner ensures that each particular food item is sufficiently heated to ensure food safety while maintaining taste and texture quality. At the same time, the utilization of the heating profile in this manner ensures that the food item has not undergone unnecessary heating that is harmful to human health, makes the food item harder to metabolize, and/or decreases the quality of taste or the quality of texture of the food item. This is in contrast to conventional systems that determine the amount of time and temperature to cook a generic food item merely as a function of changes in temperature in the heating zone. Additionally, conventional systems do not gradually increase a heater plate to a particular temperature and hold it at that temperature for a particular amount of time based on the particular food item being placed in the heating zone. Rather, conventional systems often apply an irregular sequence of heating changes based on changes in temperature of the oven of the conventional system.

Second, embodiments herein increase operator safety through the utilization of a particular heating profile for a heating zone based on the particular food item being placed in the heating zone. This is because the heating profile can specify a preheat time, a preheat temperature, a heating time, a heating temperature, a holding time during which the food item is ready to serve and after which the food item should be considered expired, and/or one or more holding temperatures specific to the particular food item being placed in the heating zone, thereby ensuring that food item does not get too hot to the touch and has had sufficient time to cool down before ending the reheating process. Moreover, embodiments herein ensure the particular heating profile is applied to the right heating zone at the time the particular food item is actually loaded into the food warming device 102. As noted above, in some embodiments, a heating profile can advantageously omit a preheat time, which is possible because pre-heating is unnecessary when heating is done primarily through conduction through the heater plate 404 instead of convection from hot air around the food item. A particular heater plate 404 will warm up in a matter of the first few minutes of a heating profile heating phase and, in such an instance, limited benefit would come from pre-warming the plate or air temperature in the heating zone.

Additionally, embodiments herein increase operator safety and efficient reheating by ensuring that a food item placed in a heating zone (e.g., heating zones 304 or 306) is assigned the correct heating profile. This ensures that the right heating profile is applied to the right food item, thereby ensuring the food item is not underheated or too hot to handle. This can be accomplished by the terminal 104 assigning an appropriate unallocated heating zone in the food warming device 102 to a specific food item, and alerting the operator through one or more indicators of the correct unallocated heating zone to place the food item within.

Embodiments herein may direct the user where to load food items (e.g., into which heating zones of which food warming devices 102-1 through 102-N individual food items should be loaded). In some embodiments, the terminal 104, in coordination with indicators of the food warming device 102, can display instructions and identify heating zones via the indicators to direct which heating zones of the food warming device should be loaded with which food items at which times. In some embodiments, a detection system may be used to validate if proper food items were loaded into the expected corresponding heating zones (e.g., heating zone 402). For example, as described above, one or more visual code scanners can be employed to scan food items as they are loaded, or individual scanners in heating zones can perform such detection.

In other embodiments, a reactive system may be utilized to support loading of the food items. For example, a worker (e.g., a staff member of food environment 100) can load the food item in any compatible heating zone (e.g., heating zone 402), and through the detection system (e.g., food presence sensor 408 or scanner), software can select the appropriate heating profile for the food item and assign the food item to a resident. The system can inform a user if they need to load more or fewer food items depending on the meal plan scheduled for that particular environment (e.g., food environment 100) and/or the calendar day.

In some embodiments, a terminal 104 may drive an attached receipt printer (not shown) that generates a summary of meal items and the associated consumer (e.g., patient or resident identifying information) as may be required in healthcare or other applications to ensure the correct meal is served to the correct consumer after that meal leaves the food preparation environment 100. For example, a terminal 104 may be connected to a receipt printer. As described above, the receipt printer can print one or more meal tickets that facilitate matching food items with the one or more consumers who will receive the food items. Each printed ticket can list the one or more food items, the name or other identifier of the consumer, an eating location, service notes, birthday notifications, nutrition summary data, and/or other consumer clinical data, consumer service data, or consumer personal data.

To further illuminate the above technological advantages, below is an example of a method 500 of how embodiments herein can be used to warm food items of a meal.

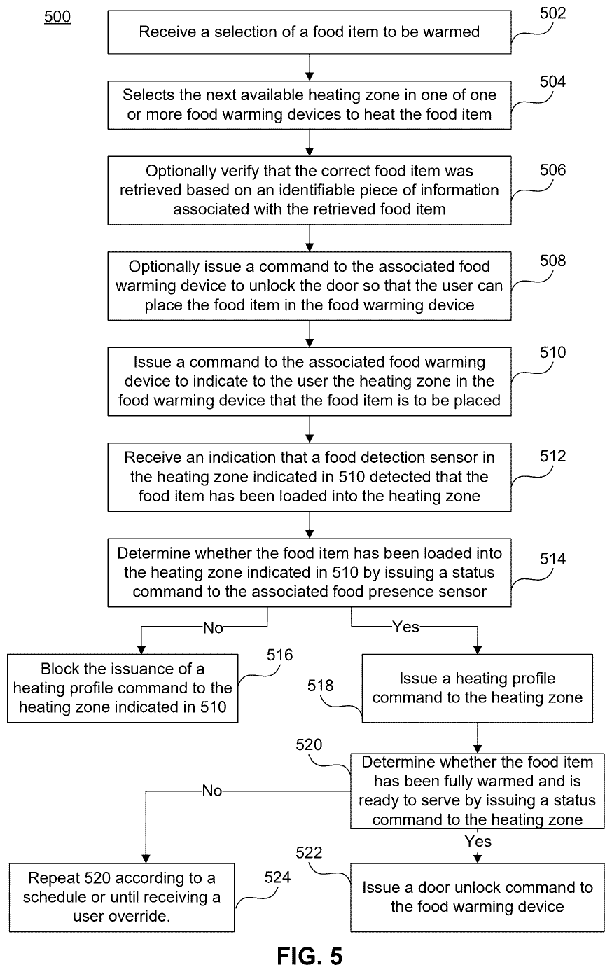

FIG. 5 is a flowchart for a method 500 for food warming, according to an embodiment. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1-4. However, method 500 is not limited to that example embodiment.

In 502, terminal 104 can receive a selection of a food item to be warmed. As one example, a user (e.g., a staff member of food environment 100) may make the selection from a user interface of the terminal 104. For example, the user may select an entree food item to be warmed from a touch screen of the terminal. As another example, a terminal 104 can be programmed with a schedule of meals to be served, and the terminal 104 can direct the user to load food items at appropriate times.

In 504, the terminal 104 can select the next available heating zone (e.g., heating zone 304 or 306) in one of the food warming devices 102-1 through 102-N to heat the food item. The terminal 104 can use various resource allocation strategies to select the optimal heating zone in one of the food warming devices. For example, the terminal 104 may select a heating zone based on the maximization of the number of meals served per unit time. Similarly, the terminal 104 may select a heating zone based on minimization of energy usage of the food warming device. To make this selection, the terminal may send a status command to a food warming device 102 to get the current state of the food warming device 102. The terminal 104 may also send a status command to a particular target component of the food warming device 102 (e.g., a shelf, heater plate, door lock, etc.) and the food warming device 102 will send back the state of the target specified in the command. The terminal 104 may utilize this status information as part of its resource allocation strategy to select the optimal heating zone in one of the food warming devices 102.

After the selection, the user may retrieve the food item from cold storage (e.g., a refrigerator at food environment 100). For example, the terminal 104 may display an instruction directing the retrieval and/or staging of certain food items (e.g., certain numbers of one or more different types of food items), e.g., according to a programmed food preparation schedule. For example, the terminal 104 may display the instruction “Get six chicken Alfredo items.”

In 506, the terminal 104 may optionally verify that the correct food item was retrieved from the cold storage based on an identifiable piece of information associated with the retrieved food item. For example, the user may optionally use a scanner to identify the food item by lot, serial number, or other identifier as would be appreciated by a person of ordinary skill in the art. This food item verification can improve traceability. For example, the user may use a bar code scanner to identify the food item by lot or serial number. The user may use various other types of scanners (e.g., a camera, Radio Frequency Identification (RFID) reader, etc.) as would be appreciated by a person of ordinary skill in the art. The terminal 104 may then verify that the correct food item was retrieved from the cold storage based the identified lot, serial number, or other identifier captured by the scanner.

In 508, the terminal 104 may optionally issue a command to the associated food warming device 102 to unlock the door 206 so that the user can place the food item in the food warming device. In embodiments in which a food warming device 102 is equipped with multiple doors (e.g., one door for each heating zone, or multiple doors each corresponding to a set of multiple heating zones), the terminal 104 can unlock only the proper doors for loading during the present loading phase, providing assurance that each loaded food item is loaded into the appropriate heating zone and will thus be heated according to the correct corresponding heating profile.

In some embodiments, the terminal 104 is only capable of locking the software-lockable door based on a door switch associated with the door detecting that the door is in a closed position. In such embodiments, when the door is open, the terminal 104 will not engage the lock. In some embodiments, the lock is a magnetic lock.

In 510, the terminal 104 may issue a command to the associated food warming device 102 to indicate to the user the heating zone in the food warming device that the food item is to be placed. For example, the terminal 104 may send a command to the associated food warming device 102 to light an indicator next to the heating zone (e.g., heating zone 304 or 306) where the food item is to be placed. Multiple heating zones can be indicated contemporaneously, e.g., to indicate where multiple food items of the same type should be loaded.

The user may then insert the food item(s) into the heating zone(s) indicated in 510.

In 512, the terminal 104 may receive an indication that a food presence sensor (e.g., food presence sensor 314 or 408) in a heating zone indicated in 510 detected that the food item has been loaded into the heating zone. As described above, the food presence sensor may detect that the food item has been loaded into the heating zone using a motion sensor, a proximity sensor, a weight sensor, an optical sensor (e.g., a laser sensor or an infrared sensor), an ultrasonic sensor, a camera, or other type of sensor as would be appreciated by a person of ordinary skill in the art.

If the food presence sensor in the heating zone detects that the food item has been loaded into the heating zone, the food warming device 102, either autonomously or at the direction of the terminal 104, may adjust one or more indicators associated with the heating zone to indicate the food item has been loaded into that heating zone. If the food presence sensor in the heating zone detects that the food item has not been loaded into the correct heating zone, the food warming device 102, either autonomously or at the direction of the terminal 104, may adjust one or more indicators associated with the correct heating zone to indicate the food item has not been loaded into it. For example, the food warming device 102 may illuminate an indicator in the correct heating zone and flash an indicator in the incorrect heating zone containing the incorrectly placed food item.

In 514, the terminal 104 may determine whether the food item has been loaded into the heating zone indicated in 510 by issuing a status command to the associated food detection sensor (e.g., foot presence detector 408).

In 516, if the terminal 104 determines the food item has been not been loaded into the heating zone indicated in 510, the terminal 104 can block the issuance of a heating profile command to the heating zone indicated in 510 until either the terminal 104 determines the food item has been removed and placed in the correct heating zone or the terminal 104 receives an override command from a user. For example, the heating profile can be held idle until a food presence sensor 314 or 408 detects that food is loaded in a heating zone.

In 518, if the terminal determines the food item has been loaded into the heating zone indicated in 510, the terminal 104 may issue a heating profile command to the heating zone, thereby causing the heating zone in the food warming device 104 to start the heating process according to an associated heating profile (e.g., to start a heating phase of the heating profile). The heating profile command may specify a heating profile to be utilized for the heating zone. As an example, the heating profile may specify a preheat time, a preheat temperature, a heating time, a heating temperature, expiration holding time during which the food item is ready to serve and after which the food item should be considered expired, and/or one or more holding temperatures to use for the heater plate in the heating zone. The terminal 104 may select the heating profile for the heating zone based on the particular food item instructed to be placed in the heating zone. For example, the terminal 104 may maintain a mapping of food items to heating profiles. The terminal 104 may select the appropriate heating profile to apply to a heating zone based on the mapping and the food item chosen 502.

The food warming device 102 may indicate the heating process is ongoing in the heating zone through a warming indicator (e.g., warming indicator 310) associated with the heating zone. For example, the food warming device 102 may illuminate the warming indicator while the heating process is ongoing in the heating zone.

The food warming device 102 may indicate the food item has been fully warmed and is ready to serve through a ready indicator (e.g., load/unload food indicator 308) associated with the heating zone. For example, the food warming device 102 may cause the ready indicator to blink and/or to light a certain color (e.g., green) once the food item has been fully warmed and is ready to serve.

In 520, the terminal 104 may determine the food item has been fully warmed and is ready to serve by issuing a status command to the heating zone (e.g., to the warming/ready indicator 310).

In addition to sending status commands to change the visual states of indicators on the food warming device 102 (e.g., of the load/unload food indicator 308, the warming/ready indicator 310, and/or the discard food indicator 312), the terminal 104 may provide parallel visual notifications via the user interface of the terminal 104 that shows a diagram of the food warming device 102 with representations of its heating zones. The terminal 102 can change the visual appearances of the representations of the heating zones to corresponding with the indicator statuses displayed on the food warming device 102. As examples, the representations of the heating zones as displayed on the user interface of the terminal 104 can be individually changed in color or in flashing/blinking state depending on the respective loading or heating statuses that align with the states of the indicators on the food warming device 102. The ability to provide parallel visual notification advantageously permits enhanced user visual correspondence of directive signals when moving between the terminal 104 and various ones of the food warming devices 102-1 through 102-N, while maintaining the benefits of a centralized command and control point at the terminal 104.

In 522, if the terminal 104 determines the food item has been fully warmed and is ready to serve, the terminal 104 may issue a door unlock command to the food warming device 102, thereby allowing a user to retrieve the food item from the heating zone. To ensure safe handling, the terminal 104 may delay issuing a door unlock command to the food warming device 102 until after a period of time has elapsed, thereby further ensuring the food item is not too hot to handle.

In 524, if the terminal 104 determines the food item has not been fully warmed or is not ready to serve, the terminal 104 may repeat 520 according to a schedule or until receiving a user override.

If there is an error any time during the heating process, or the food item stays on the heater plate too long, the food warming device 102 may trigger a food discard indicator. For example, the food warming device 102 may illuminate a food discard indicator associated with the heating zone, indicating the food item must be discarded. Subsequent food items can be warmed in the same way as described with regard to method 500.

In view of FIGS. 1 through 5, embodiments as described herein can include a food warming device 102 communicatively coupled to a terminal 104 and configured to receive a heating profile from the terminal 104 corresponding to a food item that the terminal 104 instructs to be loaded into a heating zone of the food warming device 102 (or that the terminal 104 detects has been loaded into the heating zone). The food warming device 102 can further be configured to drive a heater plate in accordance with the heating profile. The food warming device 102 can further be configured to drive each heater plate of each corresponding heating zone, of a plurality of heating zones in the food warming device 102, to a respective desired temperature based on a respective heating profile associated with the corresponding heating zone, for one or more heating phase durations specified in the heating profile. Each heating profile can specify multiple heating phases, with different temperatures and durations in each heating phase. For example, as directed by the terminal 104, a food warming device 102 can drive heater plates of respective individual heating zones to temperatures specified in respective heating profiles using closed-loop control, aided by feedback from the respective temperature sensors of the heating zones and/or the food presence sensors of the heating zones. In this manner, each heating zone can be heated separately according to a heating profile that can be different from heating profiles that govern the heating of other heating zones in the food warming device 102. Visual indicators associated with each heating zone in the food warming device 102 can be illuminated (e.g., steadily lit, blinked, flashed, lit to different colors, etc.) to indicate various statuses of the corresponding heating zone, and can be controlled by the food warming device 102 and/or the terminal 104 to assist in the instructing of loading, unloading, serving, and/or discarding of food items.

Embodiments herein also solve the technological problems of accurately and timely generating a menu plan that optimally satisfies various competing demands, including consumer food preferences, consumer dietary restrictions, consumer nutritional goals, budget constraints, inventory constraints, preparation time, and facility settings. This improvement in the generation of menu plans can reduce the workload on dietitians and food service directors to prepare meal plans.

To solve the above technological problems, embodiments herein can utilize a unique menu generation system.

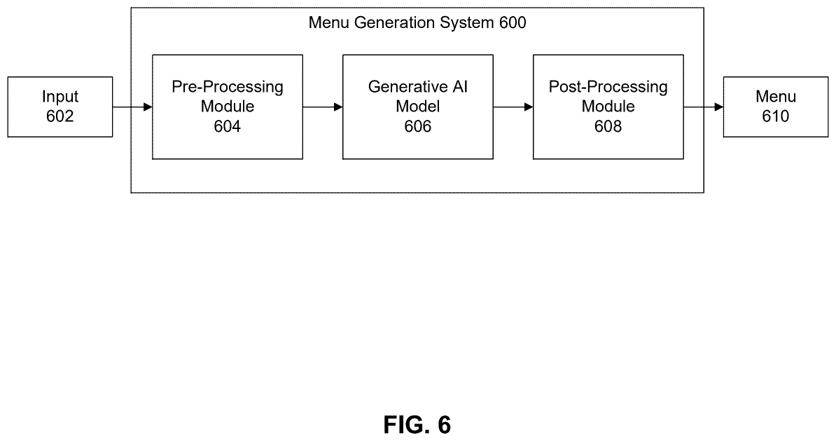

FIG. 6 illustrates a block diagram of a menu generation system 600, according to some embodiments. In a non-limiting example, menu generation system 600 may exist at food preparation environment 100. For example, the menu generation system 600 may be accessed using the terminal 104. However, this disclosure is applicable to menu generation system 600 existing at any type of food preparation environment.

Menu generation system 600 may be configured to generate one or more community menus or one or more personal menus. A community menu is a meal plan (e.g., a weekly menu) for a facility population as a whole, without generating individual personalized meal plans for the particular needs or preferences of any particular consumers within the population. The community menu may nevertheless accommodate such needs or preferences (e.g., by including options that are vegetarian, vegan, gluten-free, sodium-free or reduced sodium, sugar-free or reduced sugar, halal, kosher, tree nut or other allergen free, etc.). A community menu can thus be used to coordinate service and related planning for the entire facility population. A community menu can also be tailored based on the needs and preferences of individual consumers without generating personalized meal plans for the consumers. For example, if no consumer in the facility population lists themselves as having a certain specific dietary restriction, such as one of the ones listed above, then the community menu can be generated without catering to the specific dietary restriction. A personal menu, by contrast, is a personalized meal plan (e.g., a weekly menu) customized to the clinical needs or personal preferences of an individual consumer. The menu generation system 600 may be configured to generate a community menu or a personal menu that optimally satisfies various competing demands through the unique combination of a tagging system and a generative artificial intelligence (AI) model.

Menu generation system 600 may be implemented on a terminal, another computer system, a cloud computing environment, a computing cluster, or other type of electronic device as would be appreciated by a person of ordinary skill in the art. Menu generation system 600 may include a pre-processing module 604, a generative AI model 606, and a post-processing module 608. The menu generation system 600 can be implemented in software, in hardware, or in a combination of software and hardware. As one example, the menu generation system 600 can be implemented in software executed on one or more central processing units, e.g., in coordination with one or more graphics processing units and/or one or more AI processing units. As another example, the menu generation system 600 can be implemented as one or more application-specific integrated circuits (ASICs) configured to carry out the processing functions described in greater detail below.

Menu generation system 600 may be communicatively coupled to one or more data sources via a computer network (e.g., the internet). The one or more data sources may store consumer-specific data (e.g., consumer demographic data, consumer preferences, consumer dietary restrictions, consumer nutritional goals, etc.). The one or more data sources may also store non-consumer-specific data (e.g., facility settings, budget constraints, food inventory, food warming device and heating zone availability, food preparation time constraints, overall facility nutritional goals, etc.). The one or more data sources may include any one or more product catalogs, seasonal settings, weather forecast databases, nutrition databases, allergen databases, food vendor databases, food vendor pricing catalogs, food distributor item and price catalogs, governmental nutrition repositories (e.g., United States Department of Agriculture nutrition repositories), food item identification catalogs (e.g., the 1WorldSynch catalog), electronic medical record (EMR) databases, or other data sources as would be appreciated by a person of ordinary skill in the art.

Menu generation system 600 may allow an operator (e.g., a dietitian or food service director), via a user interface, to tag the consumer-specific data and/or the non-consumer-specific data in the one or more data sources with various metadata (e.g., textual, graphical, or other types of metadata as would be appreciated by a person of ordinary skill in the art). For example, the operator may tag a food item in the food inventory data set with nutritional information. Similarly, the operator may tag a consumer (e.g., resident, patient, or other type of consumer) in the consumer-specific data set with dietary restrictions or health conditions.

In some embodiments, an AI agent may automatically tag the consumer-specific data and/or the non-consumer-specific data. For example, the AI agent may automatically tag the consumer-specific data and/or the non-consumer-specific data based on product description, nutrition information, related data, and/or other data as would be appreciated by a person of ordinary skill in the art.

The AI agent may pre-process the consumer-specific data and/or the non-consumer-specific data. For example, the AI agent may pre-process a product catalog using metadata information to automatically tag the consumer-specific data and/or the non-consumer-specific data. The tagging can help define product suitability for various diets, textures, fluid requirements, and nutritional requirements or restrictions (e.g., low sodium requirements). A system administrator can later review the results for a compliance reason (e.g., Health Insurance Portability and Accountability Act (HIPAA) compliance).

In some embodiments, menu generation system 600 may provide one or more validation gates for tagging. These one or more validation gates can ensure tagging is complete and/or prevents the addition of incorrect or conflicting tags.

In some embodiments, an AI model can process a product (e.g., a food item) tagging during import to better understand (e.g., via different attributes of the product (e.g., name, description, nutrition, etc.)) if this is a product suitable for different meals. The AI model can also tag allergies, lifestyle diet, and/or other attributes as would be appreciated by a person of ordinary skill in the art.

Menu generation system 600 may standardize the tagged information after insertion or updating to ensure the metadata (e.g., the tagged information) is used consistently across the consumer-specific data and/or the non-consumer-specific data. For example, menu generation system 600 may convert multiple synonymous textual terms to a single, common textual term. This may allow a generative AI module (e.g., generative AI module 606) to more efficiently and accurately process the metadata when generating a menu for a user.

Menu generation system 600 may include a pre-processing module 604. Pre-processing module 604 may receive input 602 from a user. The input 602 may be in textual form, graphical form, or another input format as would be appreciated by a person of ordinary skill in the art.

Input 602 may represent a request from a user (e.g., staff or individual consumer) to generate a menu for themselves or another user subject to various preferences and constraints. For example, input 602 may specify that the user would like a Keto diet menu. Input 602 may also specify that the user would like a menu that spans a period of time (e.g., a full week). The input 602 may also specify that the user has certain taste preferences (e.g., prefers savory foods over sweet foods).

In some embodiments, menu generation system 600 can pre-process (e.g., via pre-processing module 604), in one or more environments such as food preparing environment 100, an input 602 that contains a complex array of clinical requirements such as medical conditions, diagnosis, nutrition-related laboratory values, weight status, health goals, diet orders, food texture requirements for dysphagia management, related nutritional requirements, or other information as would be appreciated by a person of ordinary skill in the art. During this pre-processing, menu generation system 600 can account for a broad spectrum of nutrients, minerals, and/or related nutritional data points, so that the menu ultimately generated by the menu generations system 600 is clinically appropriate based on the one or more food items available in the production area (e.g., food preparing environment 100).

Pre-processing module 604 may pre-process input 602. Pre-processing module 604 may standardize input 602. For example, pre-processing module 604 may convert multiple synonymous textual terms to a single, common textual term. Pre-processing module 604 may also ensure that a single, common textual term is the same textual term used by the metadata in the one or more data sources.

Pre-processing module 604 may also change one or more portions of input 602 that violate one or more rules. For example, pre-processing module 604 may delete a food item listed in input 602 that matches a rule indicating it contains a harmful or disfavored food ingredient, e.g., for an individual consumer when generating a personal menu. Similarly, pre-processing module 604 may add a food item to input 602 if a rule indicates it contains a required food ingredient.

Pre-processing module 604 may also combine input 602 with consumer-specific data and/or non-consumer-specific data in the one or more data sources. For example, pre-processing module 604 may add consumer-specific data (e.g., consumer preferences, consumer dietary restrictions, and consumer nutritional goals) associated with the user to input 602. Similarly, pre-processing module 604 may add non-consumer-specific data (e.g., facility settings, budget constraints, food inventory, food warming device and heating zone availability, food preparation time constraints, and overall facility nutritional goals) to input 602.

Pre-processing module 604 may also reorder one or more portions of input 602. Pre-processing module 604 may reorder the one or more portions of input 602 either before or after pre-processing module 604 combines input 602 with user-specific data and/or non-user specific data in the one or more data sources. Pre-processing module 604 may also reorder the one or more portions of input 602 according to one or more rules associated with generative AI module 606.

The one or more rules may specify a reordering of one or more portion types of input 602 in order to optimize the performance of generative AI module 606. For example, the one or more rules may specify a reordering of one or more portion types of input 602 in order to decrease memory usage of generative AI module 606. Similarly, the one or more rules may specify a reordering of one or more portion types of input 602 in order to decrease the response time of generative AI module 606 (e.g., the length of time between submitting an input to generative AI module 606 and receiving an output from generative AI module 606).

The one or more rules may also specify a reordering of one or more portion types of input 602 in order to increase the accuracy of the output of generative AI module 606. For example, the one or more rules may specify a reordering of one or more portion types of input 602 in order to reduce the possibility that the output from generative AI module 606 contains hallucinations (e.g., fake food items). Similarly, the one or more rules may specify a reordering of one or more portion types of input 602 in order to ensure the output from generative AI module 606 more accurately meets the constraints specified in the consumer-specific data and/or non-consumer-specific data.

Pre-processing module 604 may output the result of pre-processing input 602 to generative AI module 606. Pre-processing module 604 may output the result of pre-processing input 602 to generative AI module 606 as textual data, graphical data, or another data format as would be appreciated by a person of ordinary skill in the art.

Generative AI module 606 may be a Generative Adversarial Network (GAN), Variational Autoencoder (VAE), autoregressive model, Recurrent Neural Networks (RNN), transformer-based model, reinforcement learning for generative task model, or other type of AI model as would be appreciated by a person of ordinary skill in the art.

Generative AI module 606 may be trained according to various training data sets. For example, generative AI module 606 may trained using historical menu plans utilized at various facilities (e.g., assisted living centers).

Generative AI module 606 may output an initial menu plan based on the pre-processed input 602. Alternatively, generative AI module 606 may output an initial menu plan based on input 602 itself (i.e., without pre-processing by pre-processing module 604).

Generative AI module 606 may transmit the initial menu plan to post-processing module 608 for post-processing. Post-processing module 608 may change one or more portions of the initial menu plan that violate one or more rules. For example, post-processing module 608 may add one or more food items to the initial menu plan in order to satisfy one or more rules (e.g., to satisfy a rule that specifies a dietary need for the consumer). Similarly, post-processing module 608 may delete one or more food items from the initial menu plan in order to satisfy one or more rules (e.g., to satisfy a rule that specifies a particular food item cannot be used in a meal plan because it is currently too expensive).

Post-processing module 608 may output a menu 610 after post-processing the initial menu plan.

As discussed above, menu generation system 600 improves the generation of menu plans that optimally satisfy various competing demands, including consumer food preferences, consumer dietary restrictions, consumer nutritional goals, budget constraints, inventory constraints, preparation time, and facility settings. Menu generation system 600 may also improve the generation of menu plans that optimally satisfy goals of weight loss clinics, allergies, feeding needs in skilled nursing facilities (SNF) and/or acute care. Menu generation system 600 may also improve the generation of menu plans that optimally satisfy food textures, clinical diet orders, and/or other factors in an environment (e.g. food preparation environment 100).

This improvement in the generation of menu plans that optimally satisfy various competing demands also reduces the workload on dietitians and food service directors to prepare meal plans.

In particular, the unique use of the tagging system with pre-processing module 604 can reduce the possibility that generative AI module 606 generates a menu 610 that contains hallucinations (e.g., fake food items). The unique use of the tagging system with pre-processing module 604 can also increase the possibility that generative AI module 606 generates a menu 610 that accurately meets the constraints specified in the consumer-specific data and/or non-consumer-specific data. Similarly, the unique use of generative AI module 606 with post-processing module 604 can ensure that menu 610 does not violate consumer dietary restrictions, food inventory restrictions, or other important restrictions as would be appreciated by a person of ordinary skill in the art. Finally, the unique use of the tagging system with pre-processing module 604 can facilitate the generation of menu plans over a longer period of time (e.g., a two week meal plan). By contrast, conventional systems are unable to efficiently and accurate plan a menu subject to various constraints over longer period of time. Rather, these conventional systems are limited to planning a meal plan over the course of a short period of time (e.g., a single day).

Along with improving the accuracy of the generated menu 610, the unique use of the tagging system with pre-processing module 604 can decrease memory usage of generative AI module 606. Similarly, the unique use of the tagging system with pre-processing module 604 can decrease the response time of generative AI module 606 (e.g., the length of time between submitting an input to generative AI module 606 and receiving an output from generative AI module 606).

The unique use of the tagging system with pre-processing module 604 can also facilitate providing a granular level of control over which items (e.g., meals) can be presented to consumers (e.g., patients, residents, etc.). This can provide to consumers greater opportunities to enjoy the foods they love as opposed to the food items users (e.g., staff) would provide to them.

In some embodiments, menu generation system 600 can specify the menu be updated, changed, or provide a specified level of variation checking to ensure long-term consumer (e.g., residents) do not become bored with a standard, ever-recurring menu cycle.

After generating one or more menus, the menu generation system 600 can generate one or more shopping lists and/or food orders that can be placed with a facility's food distributor(s) for fulfillment. In this regard, the menu generation system 600 can determine needs on a “zero basis” from the menu and a facility population census, or based upon a demand calculation spanning the clinical and personal needs of all consumers (e.g., residents), the on-hand inventory, the menu cycle, information regarding outstanding orders, par stock and reorder requirements, and other factors useful to order the correct amount of food products from associated providers on a just-in-time basis. The menu generation system 600 can also accommodate the need to order extra meals for staff or guests.

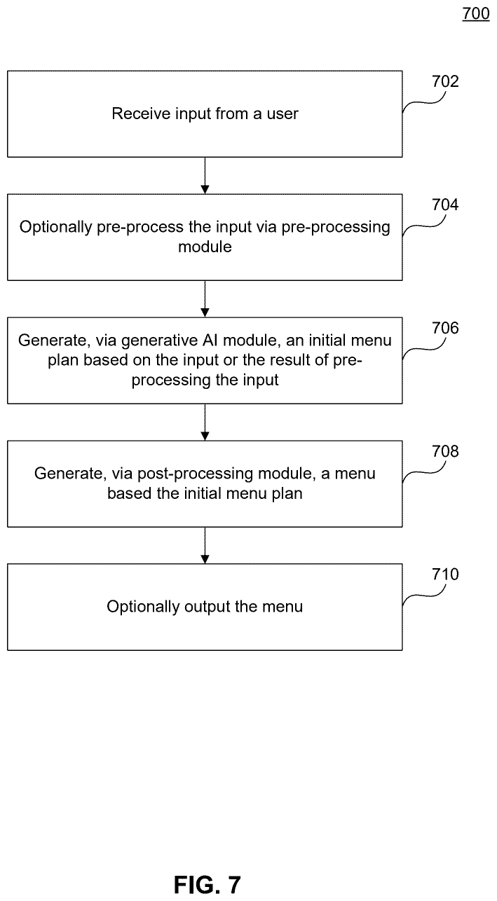

FIG. 7 is a flowchart for a method 700 for generating a personalized meal plan that optimally satisfies various competing demands, according to an embodiment. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIG. 6. However, method 700 is not limited to that example embodiment.

In 702, menu generation system 600 receives input 602 from a user (e.g., a staff member of food preparation environment 100). The input 602 may be in textual form, graphical form, or another input format as would be appreciated by a person of ordinary skill in the art.

Input 602 may represent a request from a user to generate a menu for themselves or another user subject to various preferences and constraints. For example, input 602 may specify that the user would like a Keto diet menu. Input 602 may also specify that the user would like a menu that spans a period of time (e.g., a full week). The input 602 may also specify that the user has certain taste preferences (e.g., prefers savory foods over sweet foods).

In 704, menu generation system 600 may optionally pre-process input 602 via pre-processing module 604. For example, pre-processing module 604 may convert multiple synonymous textual terms in input 602 to a single, common textual term. Pre-processing module 604 may also change one or more portions of input 602 that violate one or more rules. Pre-processing module 604 may also combine input 602 with user-specific data and/or non-user specific data in one or more data sources. Pre-processing module 604 may also reorder one or more portions of input 602.

Pre-processing module 604 may output the result of pre-processing input 602 to generative AI module 606. Pre-processing module 604 may output the result of pre-processing input 602 to generative AI module 606 as textual data, graphical data, or another data format as would be appreciated by a person of ordinary skill in the art.

In 706, menu generation system 600 can generate, via generative AI module 606, an initial menu plan based on input 602 or the result of pre-processing input 602. Generative AI module 606 may be a GAN, VAE, autoregressive model, RNN, transformer-based model, reinforcement learning for generative task model, or other type of AI model as would be appreciated by a person of ordinary skill in the art. Generative AI module 606 may be trained according to various training data sets. For example, generative AI module 606 may be trained using historical menu plans utilized at various food preparation environments (e.g., assisted living centers).

Generative AI module 606 may transmit the initial menu plan to post-processing module 608 for post-processing.

In 708, menu generation system 600 can generate, via post-processing module 608, a menu 610 based on the initial menu plan of 706. Post-processing module 608 may change one or more portions of the initial menu plan of 706 that violate one or more rules. For example, post-processing module 608 may add one or more food items to the initial menu plan of 706 in order to satisfy one or more rules (e.g., to satisfy a rule that specifies a dietary need for the consumer). Similarly, post-processing module 608 may delete one or more food items from the initial menu plan of 706 in order to satisfy one or more rules (e.g., to satisfy a rule that specifies a particular food item cannot be used in a meal plan because it is currently too expensive). For example, in some embodiments, menu generation system 600 can generate an initial menu plan of 706 that does not conflict with a specific medication.

In 710, menu generation system 600 optionally outputs the menu 610. For example, menu generation system 600 may output menu 610 in textual form, graphical form, or another output format as would be appreciated by a person of ordinary skill in the art.

In some embodiments, the output of menu generation system 600 (e.g., menu 610) can be used by a terminal 104. For example, outputting the results of menu generation system 600 to an electronic format for use on a digital signage can be used by a terminal 104.

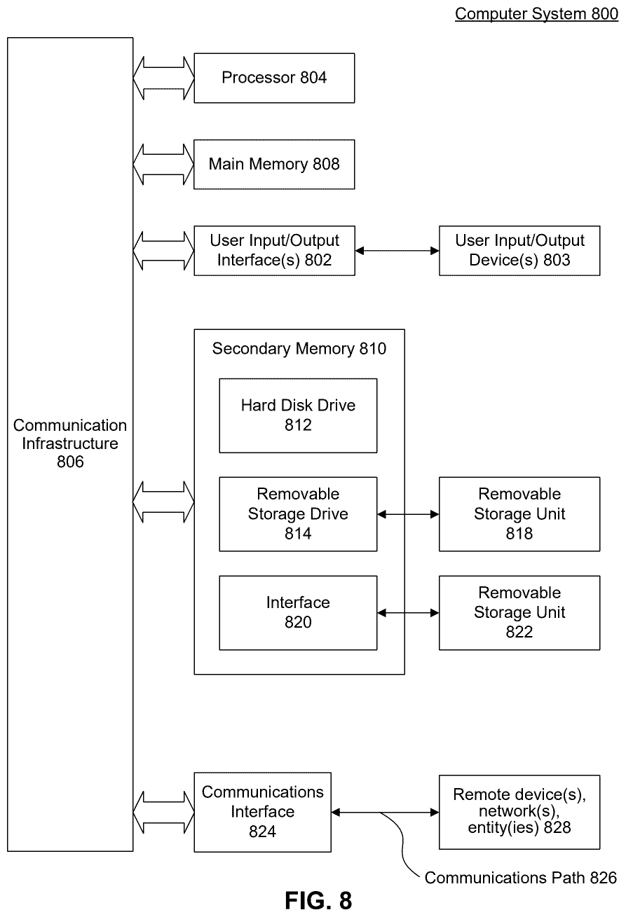

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/or any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the IoT, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

### Terminal User Interface and User Interactions

FIGS. 9 to 13 illustrate example user interface screens of an example user interface of the terminal 104. The example user interface screens illustrate views of a user interface at various points in operation of the food preparation environment 100. In the illustrated example, the food preparation environment 100 has four food warming devices 102, designated in the user interface as Heating Unit A, Heating Unit B, Heating Unit C, and Heating Unit D, respectively.

FIG. 9 shows an example user interface screen at a point in a meal preparation process in which a dinner service is upcoming in approximately two hours, and food items for the dinner service have not yet been heated. The terminal user interface instructs a user (e.g., staff) to load entrees of a same type into twelve designated bays (warming zones) in Heating Unit A and Heating Unit B. In some examples, as illustrated in FIG. 9, the terminal can instruct different types of entrees to be loaded entree type by entree type. In the illustrated example, the interface instructs the loading entrees of a “vegetable cheese omelet with hash browns” entree type into each of the twelve bays, specifically, into entree bays 1 through 8 of Heating Unit A and into entree bays 1 through 4 of Heating Unit B. As represented by different density of shading in FIG. 9, the user interface can color the entree bays to be loaded with a distinct color (e.g., light green) to contrast with entree bays not instructed to be loaded and thus to clearly indicate within the user interface which entree bays should be loaded, and which should not, at the present point in the loading process. Although not shown in FIG. 9, the corresponding matching food load/unload visual indicators 308 in FIG. 3 next to the respective bays on the food warming devices 102-1, etc., can also be illuminated distinctively, creating an easy-to-follow correspondence between the user interface on the terminal and the corresponding food warming devices 102, thus making it clear to a user which bays should be loaded, even when not looking at the terminal.

The example user interface further provides a “Skip For Now” user interface control 902 (e.g., a button, which can be, as examples, a touch-screen button, a mouse-clickable button, etc.), the activation of which will skip instructions for loading the current entree type and move on to loading instructions of the next entree type. The instructions for the loading of the current entree type can be returned to after other entrees have been loaded. The example user interface further provides a “Cancel Remaining 12 Items” user interface control 904, the activation of which will terminate instructions for loading the current entree type and move on to loading instructions of the next entree type. After clicking user interface control 904, the instructions for the loading of the current entree type will not be automatically be returned to after loading of other entrees types.

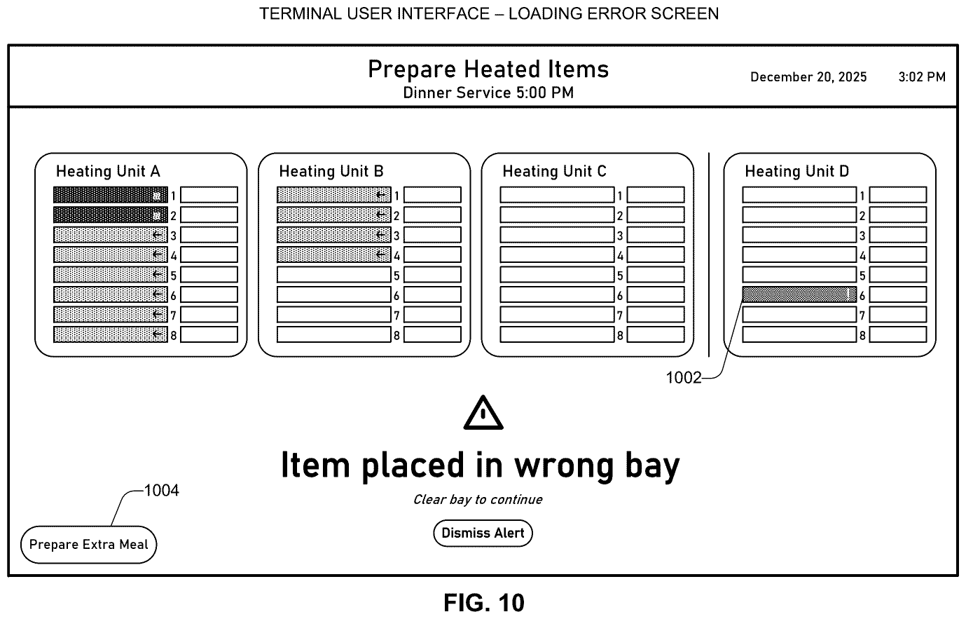

FIG. 10 shows an example user interface screen at a point in a meal preparation process shortly after the point shown in FIG. 9, when, after two entrees have been correctly loaded into bays 1 and 2 of Heating Unit A (as indicated by the different shade of those bays in FIG. 10), a third entree has been incorrectly loaded into bay 6 of Heating Unit D. The terminal can detect this non-instructed entree loading via food presence sensor 314 or 408 in the incorrectly loaded bay. The representation 1002 of this incorrectly loaded bay in the user interface can be highlighted by being shown in a different color, such as red or magenta. In some examples, it can blink or flash to attract attention, rather than remaining of a static color. In some examples, the visual indication of the misloaded bay can be accompanied by a beep, alarm, or other audible indicator emitted by the terminal. Although not shown in FIG. 10, the corresponding matching food load/unload visual indicator 308 in FIG. 3 next to the respective bays on the food warming device denoted Heating Unit C in FIG. 101 can change its illumination state (e.g., illuminate red, or blink or flash), etc., creating an easy-to-follow correspondence between the user interface on the terminal and the corresponding food warming device 102, thus making it clear to a user which bay should be unloaded, even when not looking at the terminal.

As also shown in FIG. 10, the user interface can present a context-sensitive “Prepare Extra Meal” control 1004. In the event that the non-instructed loading was intentional, the user can press this button to indicate that an extra entree—e.g., the entree loaded into bay 6 of Heating Unit D—should be prepared for the upcoming dinner service. The user interface can accordingly accommodate meals added during a loading process, without interrupting or terminating the loading process.

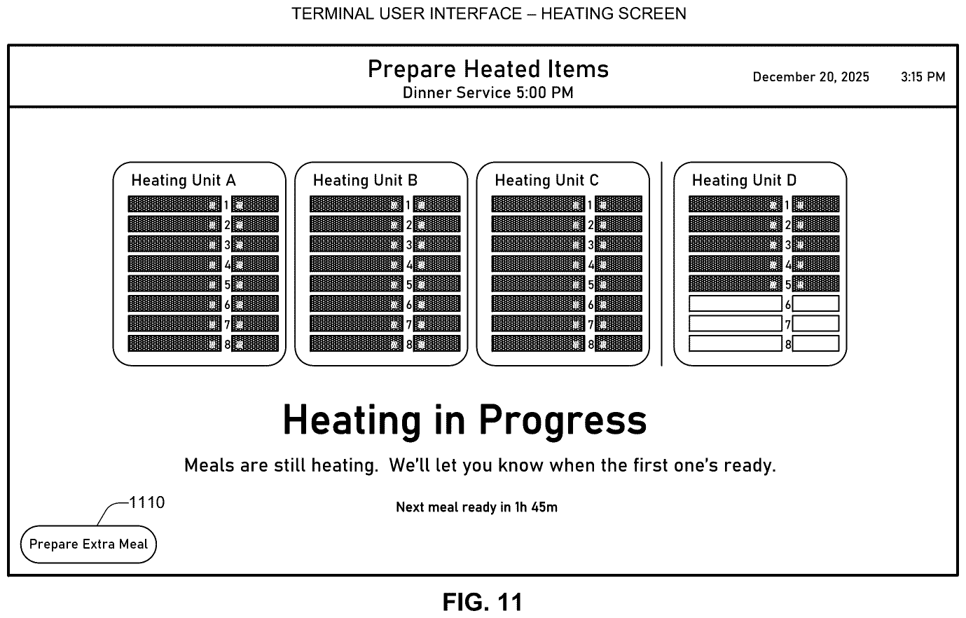

FIG. 11 shows an example user interface screen at a point in a meal heating process some time later after the point shown in FIG. 9 or FIG. 10, when, after all entrees for the upcoming diner service have been correctly loaded, the user interface can, at this point note “Heating in Progress” and can present a countdown timer to a time when the next meal to be ready will be heated and ready for consumption. In the illustrated example, that time will be one hour and forty-five minutes from the present time of 3:15 PM, or at approximately the dinner service time of 5:00.

All but six bays—three entree bays and three corresponding side dish bays at the bottom of Heating Unit D—are shown as having been loaded in FIG. 11. This can be because, for example, there were other entree types than the “vegetable cheese omelet with hash browns” entree type loaded for the upcoming service. As this point, all the loaded and warming bays are shown as shaded another shade, e.g., dark blue, on the user interface, and the corresponding bays on the food warming devices 102 can have their warming/ready indicators 310 illuminated to indicate that those bays are occupied by warming entrees and side dishes. The terminal 104 can, for example, instruct the fully loaded food warming devices corresponding to Heating Units A through C to lock their doors 206, thereby promoting safety and energy efficiency for the duration of the warming process by preventing a door to a hot compartment from being opened. The terminal 104 can, in some examples, also instruct the only partially loaded food warming device corresponding to Heating Unit D to lock its door 206.

In embodiments, the terminal 104 can unlock a door of a food warming device 102 based on the terminal 104 determining that a user needs to access the food warming device 102. For example, the terminal 104 may determine that the user interface has instructed the user to add another food item to a food warming device 102 or to remove a food item from the food warming device 102. Under such a condition, the terminal 102 can automatically unlock the food warming device 102 to which it has instructed the user to access. In some embodiments, even when all food items in a food warming device 102 have been heated and are in a holding state of their respective heating profiles, such that they are all ready to serve, the terminal can maintain the door of the food warming device 102 as locked until a user interface input to the terminal 102 indicating that a user (e.g., a staff member) is present and ready to unload the food warming device 102. Accordingly, in such embodiments, an unloading phase can be initiated only manually by a user input to the user interface and not be initiated automatically based solely on all of the food items in the food warming device 102 being ready to serve.

FIG. 11 also shows another context-sensitive “Prepare Extra Meal” control 1010. Activating this user control can cause the user interface to guide the user to load another entree into one of the non-empty bays to begin preparing that extra entrée, as well. At this point, if locked, the door 206 to Heating Unit D can be unlocked to permit one or more additional food items to be loaded into the empty bays of Heating Unit D. Although not shown in FIG. 11, the user interface view of FIG. 11 can also provide alerts as to when food items in a holding phase are about to expire, e.g., when a next-to-expire food item of the food items in any of the food warming zones is about to expire.

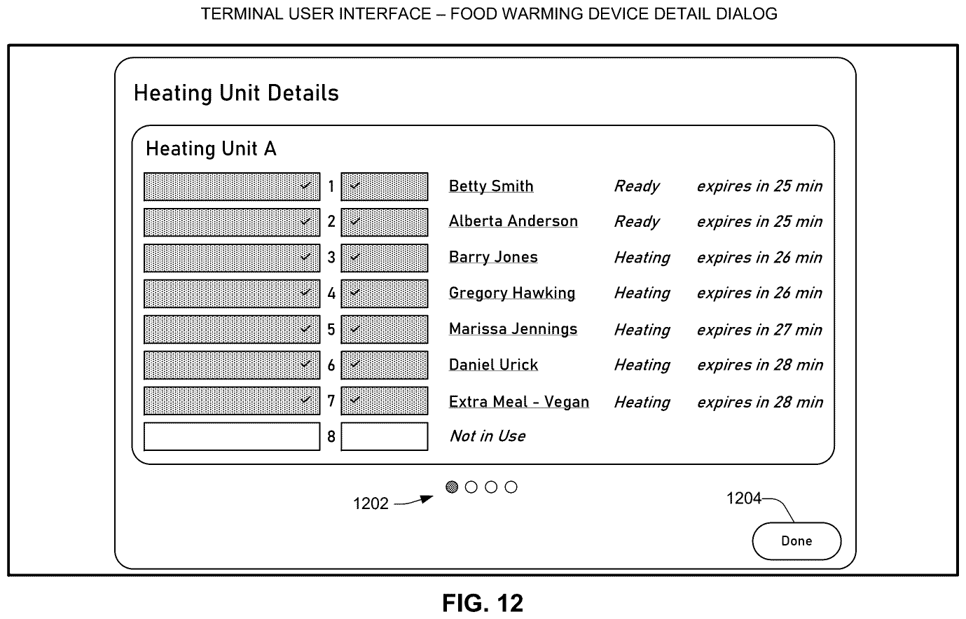

Pressing or clicking on one of the food warming units displayed in any of FIGS. 9-11 can cause the terminal to display a user interface view similar to the one shown in FIG. 12, having a pop-up dialog which shows heating progress of the food items in the bays of the examined food warming unit, individually, with statuses (e.g., “Ready,” “Heating,” or “Expired”) displayed individually for each bay, and countdown timers until expiration also displayed individually for each bay. Accordingly, the terminal 104 can display, on a visual representation of the food warming device on the user interface of the terminal, a separate countdown timer for each loaded heating zone of the food warming device, wherein the countdown timer for each loaded heating zone counts down to an expiry time for the respective food item loaded in the heating zone. In other embodiments, not shown, the countdown timer for each loaded heating zone can count down to a ready time (a time of transition from a heating phase to a holding phase in the heating profile) for the respective food item loaded in the heating zone. The names of the consumers associated with the individual food items are also displayed individually for each bay in the user interface view of FIG. 12. Page change controls 1202 can be used to navigate between different pages of the pop-up dialog corresponding to the different food warming units. In some embodiments, left and right swiping motions on the dialog may also switch between pages of the dialog corresponding to the different food warming units. A “Done” user interface control 1204 can be activated to close the pop-up dialog.

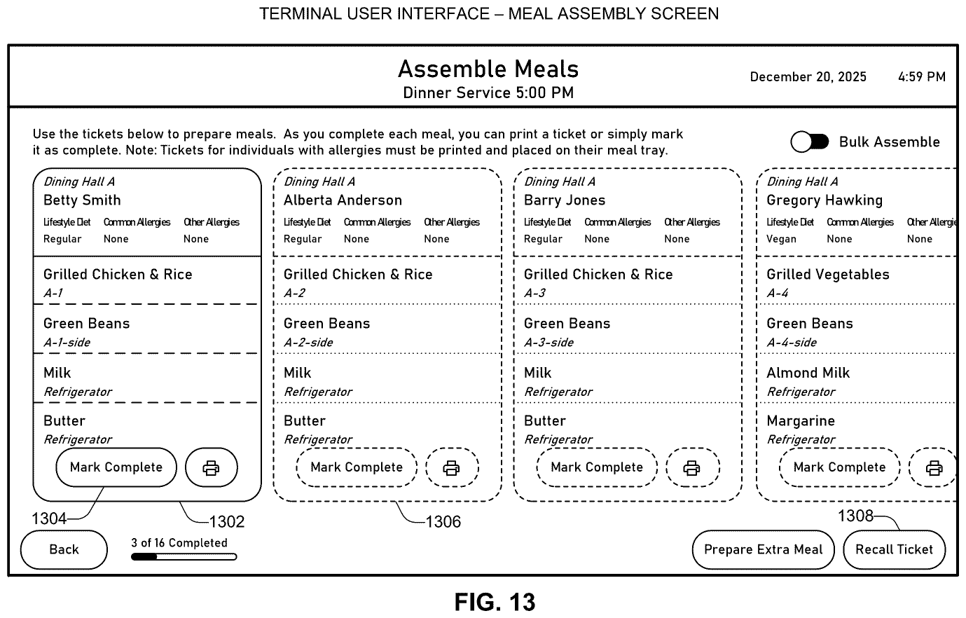

FIG. 13 shows a user interface screen at a point in a meal heating process some time later after the point shown in FIG. 11, when entrees are ready to be unloaded and prepared for the dinner service. This service preparation can involve, for example, assembling the heated entree (and corresponding side dish, if any) with one or more cold items (e.g., a beverage, condiment, salad, sandwich, etc.) for each consumer being served at the dinner service, in accordance with meal assembly instructions shown in meal tickets in the view of FIG. 13. Individual meals are shown in separate meal tickets in a scrollable view, e.g., with one such meal ticket shown at 1302. Each meal ticket can indicate a name of a consumer of the meal associated with the meal ticket, the entree and side dish type (if any), and any other items, such as cold items, to be assembled with the entree and/or side dish prior to service. Each meal ticket can also indicate a location of a heated entree and/or side dish in the one or more respective food warming devices (e.g., “A-4” can indicate Heating Unit A, bay 4). A “Mark Complete” control 1304 within the dialog 1302 can be activated to indicate that the meal has been assembled and completed. Once activating the “Mark Complete” control for a meal ticket, the corresponding meal ticket can become disabled within the user interface view, as indicated by broken line meal tickets such as meal ticket 1306 in FIG. 13. Active meal tickets can be printed using a print button. If a ticket is marked complete prematurely, it can be recalled via the “Recall Ticket” control 1308.

The illustrated user interface views are intended to be representative examples for purposes of illustration. The terminal 104 can be capable of presenting many other user interface views and configurations of such views.

### Conclusion

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A food warming system comprising:
a food warming device comprising:
a housing;
a first heating zone and a second heating zone each arranged on a shelf or a respective shelf of the housing, each of the first and second heating zones comprising:
a thermally conductive heater plate;
a temperature sensor; and
a food presence sensor;
control circuitry electrically coupled to the heater plate of the first heating zone, the heater plate of the second heating zone, the temperature sensor of the first heating zone, and the temperature sensor of the second heating zone and configured to:
drive the heater plate of the first heating zone to a first series of temperatures according to a first heating profile and based on a first feedback signal from the temperature sensor of the first heating zone; and
drive the heater plate of the second heating zone to a second series of temperatures according to a second heating profile and based on a second feedback signal from the temperature sensor of the second heating zone;
a first plurality of lighted visual indicators associated with the first heating zone; and
a second plurality of lighted visual indicators associated with the second heating zone; and
a terminal, physically distinct from the food warming device and communicatively coupled to the control circuitry of the food warming device, the terminal comprising:
a display configured to show a user interface of the terminal; and
a processor configured to perform operations comprising:
displaying, on the user interface, food item loading instructions according to a scheduled food preparation menu, the food item loading instructions including a first loading instruction for a first food item to be warmed in the first heating zone and a second loading instruction for a second food item to be warmed in the second heating zone;
activating a first loading visual indicator on the first plurality of lighted visual indicators associated with the first heating zone, to place the first loading visual indicator in a first visual indicator state, based on the scheduled food preparation menu;
activating a second loading visual indicator on the second plurality of lighted visual indicators associated with the second heating zone, to place the second loading visual indicator in the first visual indicator state, based on the scheduled food preparation menu;
displaying, on the user interface, a visual representation of the food warming device including visually distinct indicators of the first heating zone and the second heating zone corresponding to the first loading visual indicator and the second loading visual indicator; and
commanding the control circuitry to control heating of the first heating zone according to the first heating profile and heating of the second heating zone according to the second heating profile.

2. The food warming system of claim 1, wherein the housing comprises a software-lockable door, and wherein the operations further comprise:
detecting, based on a signal from the food presence sensor of the first heating zone, that the first heating zone has been loaded with the first food item;
detecting, based on a signal from the food presence sensor of the second heating zone, that the second heating zone has been loaded with the second food item; and
commanding a locking of the software-lockable door based on the detecting that the first heating zone has been loaded with the first food item and based on the detecting that the second heating zone has been loaded with the second food item.

3. The food warming system of claim 1, wherein the operations further comprise:
detecting, based on a signal from the food presence sensor of the first heating zone, that the first heating zone has not been loaded with the first food item;
detecting, based on a signal from a food presence sensor of a third heating zone, that the third heating zone has been loaded with a food item; and
based on the detecting that the first heating zone has not been loaded with the first food item and that the third heating zone has been loaded with a food item:
activating, to a second visual indicator state, a third loading visual indicator on a third plurality of lighted visual indicators associated with the third heating zone; and
displaying, on the user interface, a visual representation of the food warming device or another food warming device including a visually distinct indicator of the third heating zone corresponding to the third loading visual indicator.

4. The food warming system of claim 3, wherein the food warming device is a first food warming device, and wherein the food warming system comprises a second food warming device comprising the third heating zone.

5. The food warming system of claim 1, wherein each of the first heating profile and the second heating profile comprises a temperature or a series of temperatures with respect to time for at least a heating phase and a holding phase.

6. The food warming system of claim 5, wherein the operations further comprise displaying, on the user interface, and via a change in illumination state of a discard food visual indicator on the food warming device and associated with the first heating zone, that a food item in the first heating zone has been held in the holding phase beyond an expiration time defined in the first heating profile.

7. The food warming system of claim 1, wherein the operations further comprise displaying, on the visual representation of the food warming device on the user interface of the terminal, a separate countdown timer for each loaded heating zone of the food warming device, wherein the countdown timer for each loaded heating zone counts down to an expiry time for the respective food item loaded in the heating zone.

8. The food warming system of claim 1, wherein the food warming device is a first food warming device, and wherein the system comprises a second food warming device, and wherein the operations further comprise displaying, on the user interface, a visual representation of the second food warming device including indicators of heating zones of the second food warming device, wherein the indicators correspond to illumination states of visual indicators of the second food warming device that are respectively associated with the heating zones of the second food warming device.

9. A computer-implemented method of food warming, comprising:
displaying, on a user interface of a terminal physically distinct from a food warming device and communicatively coupled to control circuitry of the food warming device, food item loading instructions according to a scheduled food preparation menu, the food item loading instructions including a first loading instruction for a first food item to be warmed in a first heating zone of the food warming device and a second loading instruction for a second food item to be warmed in a second heating zone of the food warming device;
activating a first loading visual indicator of a first plurality of lighted visual indicators on the food warming device associated with the first heating zone, to place the first loading visual indicator in a first visual indicator state, based on the scheduled food preparation menu;
activating a second loading visual indicator of a second plurality of lighted visual indicators on the food warming device associated with the second heating zone, to place the second loading visual indicator in the first visual indicator state, based on the scheduled food preparation menu;
displaying, on the user interface, a visual representation of the food warming device including visually distinct indicators of the first heating zone and the second heating zone corresponding to the first loading visual indicator and the second loading visual indicator; and
commanding control circuitry of the food warming device to control heating of the first heating zone according to a first heating profile and heating of the second heating zone according to a second heating profile,
wherein the food warming device comprises a housing, the first heating zone and the second heating zone each being arranged on a shelf or a respective shelf of the housing,
wherein each of the first and second heating zones comprises:
a thermally conductive heater plate;
a temperature sensor; and
a food presence sensor, and
wherein the control circuitry is electrically coupled to the heater plate of the first heating zone, the heater plate of the second heating zone, the temperature sensor of the first heating zone, and the temperature sensor of the second heating zone and is configured to:
drive the heater plate of the first heating zone to a first series of temperatures according to the first heating profile and based on a first feedback signal from the temperature sensor of the first heating zone; and
drive the heater plate of the second heating zone to a second series of temperatures according to the second heating profile and based on a second feedback signal from the temperature sensor of the second heating zone.

10. The computer-implemented method of claim 9, wherein the housing comprises a software-lockable door, the computer-implemented method further comprising:
detecting, based on a signal from the food presence sensor of the first heating zone, that the first heating zone has been loaded with the first food item;
detecting, based on a signal from the food presence sensor of the second heating zone, that the second heating zone has been loaded with the second food item; and
commanding a locking of the software-lockable door based on the detecting that the first heating zone has been loaded with the first food item and based on the detecting that the second heating zone has been loaded with the second food item.

11. The computer-implemented method of claim 9, further comprising:
detecting, based on a signal from the food presence sensor of the first heating zone, that the first heating zone has not been loaded with the first food item;
detecting, based on a signal from a food presence sensor of a third heating zone, that the third heating zone has been loaded with a food item; and
based on the detecting that the first heating zone has not been loaded with the first food item and that the third heating zone has been loaded with a food item:
activating, to a second visual indicator state, a third loading visual indicator on a third plurality of lighted visual indicators associated with the third heating zone; and
displaying, on the user interface, a visual representation of the food warming device or another food warming device including a visually distinct indicator of the third heating zone corresponding to the third loading visual indicator.

12. The computer-implemented method of claim 11, wherein the food warming device is a first food warming device, and wherein the third heating zone is in a second food warming device.

13. The computer-implemented method of claim 9, wherein each of the first heating profile and the second heating profile comprises a temperature or a series of temperatures with respect to time for at least a heating phase and a holding phase.

14. The computer-implemented method of claim 13, further comprising displaying, on the user interface, and via a change in illumination state of a discard food visual indicator on the food warming device and associated with the first heating zone, that a food item in the first heating zone has been held in the holding phase beyond an expiration time defined in the first heating profile.

15. The computer-implemented method of claim 9, further comprising displaying, on the visual representation of the food warming device on the user interface of the terminal, a separate countdown timer for each loaded heating zone of the food warming device, wherein the countdown timer for each loaded heating zone counts down to an expiry time for the respective food item loaded in the heating zone.

16. The computer-implemented method of claim 9, wherein the food warming device is a first food warming device, and wherein the method further comprises displaying, on the user interface, a visual representation of a second food warming device communicatively coupled to the terminal, including indicators of heating zones of the second food warming device, wherein the indicators correspond to illumination states of visual indicators of the second food warming device that are respectively associated with the heating zones of the second food warming device.

17. A food warming device comprising:
a housing;
a first heating zone and a second heating zone each arranged on a shelf or a respective shelf of the housing, each of the first and second heating zones comprising:
a thermally conductive heater plate;
a temperature sensor; and
a food presence sensor;
control circuitry electrically coupled to the heater plate of the first heating zone, the heater plate of the second heating zone, the temperature sensor of the first heating zone, and the temperature sensor of the second heating zone and configured to:
drive the heater plate of the first heating zone to a first series of temperatures according to a first heating profile and based on a first feedback signal from the temperature sensor of the first heating zone; and
drive the heater plate of the second heating zone to a second series of temperatures according to a second heating profile and based on a second feedback signal from the temperature sensor of the second heating zone;
a first plurality of lighted visual indicators associated with the first heating zone, including a first loading visual indicator; and
a second plurality of lighted visual indicators associated with the second heating zone, including a second loading visual indicator;
wherein the control circuitry of the food warming device is configured to be communicatively coupled to a terminal that is physically distinct from the food warming device and is configured to be commanded to control heating of the first heating zone according to the first heating profile and heating of the second heating zone according to the second heating profile,
wherein the first loading visual indicator is configured to be activated to place the first loading visual indicator in a first visual indicator state based on a first signal from the terminal that is based on a scheduled food preparation menu,
wherein the second loading visual indicator is configured to be activated to place the second loading visual indicator in the first visual indicator state based on a second signal from the terminal that is based on the scheduled food preparation menu, and
wherein the terminal is configured to display visually distinct indicators of the first heating zone and the second heating zone corresponding to the first loading visual indicator and the second loading visual indicator, respectively, in a visual representation of the food warming device shown on a user interface on a display of the terminal.

18. The food warming device of claim 17, wherein the housing comprises a software-lockable door, and wherein the control circuitry is further configured to:
detect, based on a signal from the food presence sensor of the first heating zone, that the first heating zone has been loaded with a first food item;
detect, based on a signal from the food presence sensor of the second heating zone, that the second heating zone has been loaded with a second food item; and
command a locking of the software-lockable door based on the detecting that the first heating zone has been loaded with the first food item and based on the detecting that the second heating zone has been loaded with the second food item.

19. The food warming device of claim 17, wherein the control circuitry is further configured to:
detect, based on a signal from the food presence sensor of the first heating zone, that the first heating zone has not been loaded with a first food item;
detect, based on a signal from a food presence sensor of a third heating zone, that the third heating zone has been loaded with a food item; and
based on detecting that the first heating zone has not been loaded with the first food item and that the third heating zone has been loaded with a food item:
activate, to a second visual indicator state, a third loading visual indicator on a third plurality of lighted visual indicators associated with the third heating zone; and
cause display, on the user interface, a visual representation of the food warming device or another food warming device including a visually distinct indicator of the third heating zone corresponding to the third loading visual indicator.

20. The food warming device of claim 17, wherein each of the first heating profile and the second heating profile comprises a temperature or a series of temperatures with respect to time for at least a heating phase and a holding phase.

21. The food warming device of claim 20, wherein the control circuitry is further configured to cause display, on the user interface, and via a change in illumination state of a discard food visual indicator on the food warming device and associated with the first heating zone, that a food item in the first heating zone has been held in the holding phase beyond an expiration time defined in the first heating profile.

22. The food warming device of claim 17, wherein the terminal is further configured to display, on the visual representation of the food warming device on the user interface of the terminal, a separate countdown timer for each loaded heating zone of the food warming device, wherein the countdown timer for each loaded heating zone counts down to an expiry time for a respective food item loaded in the heating zone.
